(19) United States
(12) Patent Application Publication
(10) Pub. No.: US 2011/0099022 A1
(43) Pub. Date: Apr. 28, 2011

(54) Methods and Systems for Vehicle Emission Reporting

(76) Inventor: Andrzej Stochniol, London (GB)

(21) Appl. No.: 12/910,802

(22) Filed: Oct. 23, 2010

Related U.S. Application Data
(60) Provisional application No. 61/254,730, filed on Oct. 25, 2009.

(51) Int. Cl. G06Q 10/00; G06Q 30/00

(52) U.S. Cl. 705/1.1

(57) ABSTRACT

Systems and methods for reporting emissions from vehicles operating in and between several areas or countries are provided. In particular, an embodiment of the present invention is a method for reporting emissions from vehicles of a type, from a given activity in and between several areas, over a period of time, each vehicle associated with a fuel entity, the method comprising: providing an electronic registry (200) through which data is recorded and managed, registering each fuel entity as a fleet (400), obtaining and recording fuel consumption for each vehicle from the fleets (420), calculating attributed fuel consumption for an area, in relation to a total of fuel consumption and a predetermined usage-to-area attribution rule, wherein the rule is unrelated to both the amount of fuel purchased and fuel consumed at the area (440), optionally, deriving attributed emissions from attributed fuel consumption (460), and reporting attributed fuel consumption or attributed emissions, for at least one area (480).

### CROSS-REFERENCE TO RELATED APPLICATIONS

This application claims the benefit of provisional patent application Ser. No. 61/254,730, filed Oct. 25, 2009 by the present inventor.

### FEDERALLY SPONSORED RESEARCH

Not Applicable

### SEQUENCE LISTING

Not Applicable

### BACKGROUND OF THE INVENTION

1. Field of Invention

The present invention relates to a method and system to report fuel consumption and emissions from vehicles operating across several areas, in particular emissions of greenhouse gases.

2. Prior Art

For more than a decade numerous unsuccessful attempts have been made to create a market-based scheme to address growing greenhouse gas (GHG) emissions from the international use of transport vehicles. Emission trading, based on cap-and-trade schemes, has been widely suggested but so far has proved unsuitable. The possibility of using emission fees internationally, although suggested, has not been taken either. Some even have discounted such fees by associating them with unpopular taxes.

In nearly all attempts, a quantity-based scheme has been preferred over a price-based one. Quantity-based schemes, such as the European Union Emission Trading Scheme (EU ETS), set an overall limit or a cap on emissions and let the market decide the price for emissions. A quantity emission cap is defined, typically, for each participant; emission allowances are distributed to the participants, and subsequently traded on emission markets. The alternative to these cap-and-trade schemes is a price-based scheme, which sets the price for emissions and leaves the market forces to drive down emissions. An environmental tax is an example of a price-based scheme.

Uniform approaches have been proposed, that apply to all ships, or aircraft in the same way, irrespective of country of registration, operator, and owner. They have been discussed at the International Civil Aviation Organization (ICAO) and at the International Maritime Organization (IMO), and elsewhere. These uniform approaches have been discounted by developing countries as not complying with the principle of common but differentiated responsibilities and respective capabilities (CBDR). The CBDR principle is embodied in the United Nations Framework Convention on Climate Change (UNFCCC).

### Methodological and Trading Scheme Barriers

Given these unsuccessful attempts, two central barriers to address emissions from international transport have become apparent:

1. Lack of equitable attribution of emissions;

2. Lack of simple, scalable reporting of emissions.

The first central barrier has been, and still is, how to fairly attribute or account for emissions from mobile vehicles moving between countries. These emissions often happen outside of national borders or jurisdiction. This obstacle is particularly challenging for vehicles operating between countries at different levels of economic development, often referred to as developed and developing countries. These countries have different responsibilities under the UNFCCC. Only Annex I parties of the UNFCCC, mostly developed countries, are committed to make quantitative national commitments to reduce emissions. Due to this, emissions from fuels used for international maritime transport and aviation (so called international bunker fuels) are excluded from national emission totals and are outside the Kyoto Protocol. This attribution problem has proved insurmountable for over a decade.

Part of the issue is that current reporting of international transport emissions is based on the amount of international bunker fuels sold in a country. Typically this amount is estimated. The Final Mandatory Reporting of GHG Rule, 2009, by the Environment Protection Agency (EPA) in the United States (USA) is also based on fuel sold by suppliers. The EPA Rule is focused on domestic regulation and currently does not separate international bunker fuels. Irrespective whether the amount of such fuel is estimated or measured, and how accurate it is, this approach does not reflect the responsibility for emissions from vehicles engaged in international transport. It is the end users, such as importers of goods and travelers, who create demand for transport services. Thus, an international emission reporting scheme that aims to be fair, and comply with the principle of polluter-pays, should reflect the end user responsibility for vehicle emissions.

The second central barrier is related to feasibility of reporting emissions from tens of thousands of vehicles moving between different countries. If such reporting were to directly reflect end users' responsibility for emissions, complex systems would be required, tracking not only the vehicles but also millions of end users.

The second barrier is how to create a reporting system that is simple, offering a low cost of compliance, which is globally scalable. So far, the predominant industry view has been that creating such a reporting system is too complex and not practical. Therefore, instead the current reporting proposals envisage only reporting of emissions by vehicle operator or fuel supplier, typically on a national or regional basis. As an example, the inclusion of aviation within the EU ETS requires aircraft operators to provide data per country and route flown.

Additionally, the following two barriers to the establishment of an emission trading scheme in transport have become apparent:

1. Lack of a reliable emission baseline;

2. Lack of agreement on the distribution of emission allowances to participants.

An emission baseline or an emission status quo is the quantity of emissions of a sector in a given year. In transport, emission baselines are uncertain as reliable fuel consumption data is generally not available. Often the estimates for the emission baselines vary widely. For instance, estimates for international maritime transport vary by as much as a factor of two. At the same time, the crash of the carbon market within the EU ETS in 2006 made the requirement for accurate emission data undisputable.

The second trading barrier, distribution of allowances, has two aspects: how to distribute the emission allowances, and to whom.

To whom the allowances should be distributed is complicated by the variety and large number of transport entities. The relationships between vehicle owners, operators, charterers, and other actors engaged in transport are complex and change frequently. In non-transport industries the owner or operator of an emission source, such as a power plant, is made accountable for its emissions. However in transport, when a vehicle is chartered, hired or similar, the owner's influence on its emissions stops, and hence so should his or her accountability. Therefore, it is a challenge to select a single entity to be accountable for vehicle emissions over long time. This is even before the large number of transport entities is considered.

The second part of the distribution barrier is the question of how to distribute the emission allowances to the participating entities in a fair manner. The question is how many allowances each participant should be given. Two standard approaches from other industries include grandfathering and benchmarking. The grandfathering approach is based on historical emissions. The benchmarking approach is based on allocating emission quotas in relation to efficiency measures of the entities under the regime. Both approaches require reliable data, including fuel consumption. Furthermore, creating operational benchmarks in relation to fuel consumption has proved a challenge, especially in shipping where a diverse set of vessels operate in diverse conditions. Neither approach to distributing emission allowances seems practical in the near-term, at least for shipping.

### Two Overlooked Elements

Novel holistic approaches aimed at reporting and reducing international vehicle emissions have thus far been inhibited by the aforementioned barriers, transport complexities and scale, and lack of joined-up vision. Several important elements have not been practically connected by anyone to create a foundation for an effective emission reduction scheme. These include:

1. An emission price created by the market for emission reduction credits;

2. Innovative financing for action on climate change.

The existence of markets for emission reduction credits, units, and allowances have led to the emergence of an emission price. Carbon markets for carbon dioxide emission allowances and its equivalents are maturing rapidly. The largest of them is the EU ETS. The maturing of these markets provides an opportunity to create innovative emission reduction schemes by linking them to the established carbon price. Such price-based schemes have not yet been proposed. In contrast, numerous options have been suggested for quantity based

Secondly, the existing proposals for emission reduction schemes do not adequately address innovative financing for action on climate change, including the adaptation needs of developing countries. Given that the most vulnerable countries are likely to be hit hardest by the impact of changing climate, adaptation to climate change is increasingly considered equally important as climate change mitigation. Traditional schemes however, including cap-and-trade, inherently focus on emission reductions. Only recently have suggestions been made to allocate limited revenues from emission allowance auctioning to climate change adaptation.

The adaptation needs of developing countries are estimated at tens of $billions per annum, with a very significant funding gap in the anticipated global contributions. In June 2008 the UNFCCC Adaptation Fund had only $58 million available, an amount described as paltry when compared with the UN call for at least $86 billion in new financing by 2016. Recent estimates are even higher, and public funding will not be enough. Thus, it is important to create new innovative sources of financing for climate change action.

Taking advantage of the above overlooked elements, and aiming to eliminate the barriers described, a method and system to report fuel consumption and emissions from transport vehicles is proposed below. The method and system is further expanded by introducing an emission fee, and thereby constituting a price-based emission reduction scheme for vehicles. Such a scheme therefore can simultaneously generate additional financing. This financing could be directed to climate change adaptation in developing countries, supplemental emission reductions in forestry, and for technology transfer and transformation in the transport sector.

### SUMMARY

In response to the foregoing challenges, the Applicant has developed a novel scheme for reporting emissions from vehicles in a multi-area setting. The scheme consists of a novel system and a novel method. Emissions are from vehicles of a type, from a given activity in and between several areas, and over a period of time. Each vehicle is associated with a fuel entity, typically the entity that pays for vehicle fuel. The preferred, general embodiment for a multi-area emission reporting scheme for vehicles comprises:
(a) providing an electronic registry through which data is recorded and managed,
(b) registering each fuel entity as a fleet,
(c) obtaining and recording fuel consumption for each vehicle, for the given activity over the period of time, wherein fuel consumption is obtained from the fleets,
(d) calculating attributed fuel consumption, for at least one area, in relation to a total of fuel consumption and a predetermined usage-to-area attribution rule, wherein the rule is unrelated to both the amount of fuel purchased and fuel consumed at the area,
(e) optionally, deriving attributed emissions from attributed fuel consumption,
(f) reporting attributed fuel consumption or attributed emissions, for at least one area.

Thus the emissions from the vehicles are equitably apportioned to the several areas according to the usage-to-area attribution rule. Attributed emissions are reported for at least one area, thereby enabling their incorporation in the overall emission reporting for that area. Alternatively, attributed fuel consumption is reported instead of attributed emission. Furthermore, this reporting enables differentiated emission reduction schemes, including rebates to areas with low responsibilities for and capabilities to reduce emissions.

Several embodiments for the multi-area emission reporting scheme are described in this Application. Each of these can be integrated into a market-based emission reduction scheme aimed at reducing vehicle emissions. An embodiment based on emission fees is described.

The embodiments described may specifically apply to emission reporting and reduction from vehicles engaged in international aviation and international maritime transport.

### DRAWINGS—FIGURES

In order to assist the understanding of this invention, reference will now be made to the appended drawings, in which like reference characters refer to like elements. The drawings are exemplary only, and should not be construed as limiting the invention.

FIG. 1 is a block diagram introducing key elements and illustrating an embodiment of the present invention to report vehicle emissions;

FIG. 2 is a diagram depicting a multi-area emission reporting system for vehicles, according to an embodiment of the present invention;

FIGS. 3A to 3B are graphs illustrating representative input and output data, respectively, according to an embodiment of the present invention;

FIG. 4 is a flow chart depicting a method of reporting attributed fuel consumption or attributed emissions for a selected area, according to a first, general embodiment of the present invention;

FIGS. 5A to 5C are flow charts depicting methods of reporting attributed fuel consumption or attributed emissions for every type and every activity of vehicles, according to a second embodiment of the present invention;

FIG. 6 is a flow chart depicting a method of reporting attributed fuel consumption for international and for domestics activities of vehicles, according to a third embodiment of the present invention;

FIG. 7 is a diagram depicting a logic of calculating international and domestic portions of attributed fuel consumption, according to a fourth embodiment of the present invention;

FIG. 8 is a diagram depicting a multi-area emission reduction system for vehicles, according to a fifth embodiment of the present invention;

FIG. 9 is a flow chart depicting a method of reporting attributed emissions and obtaining emission fees from vehicles, according to a fifth embodiment of the present invention;

FIGS. 10A to 10B are graphs illustrating two types of emission reduction goals, utilized in embodiments of the present invention.

### DRAWINGS—REFERENCE NUMERALS

The following reference numerals are used in this Application:
20 multi-area emission reporting system for vehicles;
40 method of the present invention according to first, general embodiment;
50 method of the present invention—second embodiment, first variant;
54 method of the present invention—second embodiment, second variant;
58 method of the present invention—second embodiment, third variant;
60 method of the present invention according to third embodiment;
80 multi-area emission reduction system for vehicles;
90 method of the present invention according to fifth embodiment;
100 vehicle;
101 vehicle identifier (ID);
102 vehicle type;
103 vehicle activity;
105 period;
108 vehicle fuel consumption (FC);
110 first area, exemplary;
120 second area, exemplary;
125 selected area;
150 fuel entity, fleet;
151 fleet identifier (FID);
160 multi-area emission reporting scheme;
170 usage-to-area attribution rule (UTA rule);
180 total fuel consumption (TFC);
185 attributed fuel consumption (AFC);
190 total emissions;
195 attributed emissions;
200 electronic registry;
210 communication unit, of electronic registry;
220 reporting system;
222 attribution rules;
224 control logic;
226 data storage;
250 fleet admin;
260 reporting unit;
262 data sources;
268 fuel report;
270 communication unit, of fleet admin;
300 main data;
310 additional data;
350 main record;
360 optional record;
400 register fuel entities as fleets;
420 obtain and record fuel consumption;
440 calculate attributed fuel consumption (AFC);
460 derive attributed emissions, optionally;
480 report attributed fuel consumption (AFC) or attributed emissions;
500 repeat method 40 for every vehicle type;
520 consolidate reports per vehicle type;
540 repeat method 40 for every vehicle activity;
560 consolidate reports per vehicle activity;
580 repeat method 40 for every vehicle type and activity;
590 consolidate reports per vehicle type and activity;
600 execute method 40 for international activity;
620 execute method 40 for domestic activity, by using fuel consumption per area, and summing it up;
640 report attributed fuel consumption, international and domestic;
700 international TFC;
702 international UTA rule;
705 international AFC;
720 domestic TFC;
722 domestic UTA rule;
725 domestic AFC;
750 total domestic share of total activities (TD share of TA);
800 fee collection system;
810 payment account;
811 identifier PID, for payment account;
820 emission price;
850 fee payer;
880 rebate receiver;
900 obtain and record fees;
902 obtain and record a prepayment; optional;
904 obtain and record a true-up fee;
920 pay out attributed rebates;
940 disburse remaining funds.

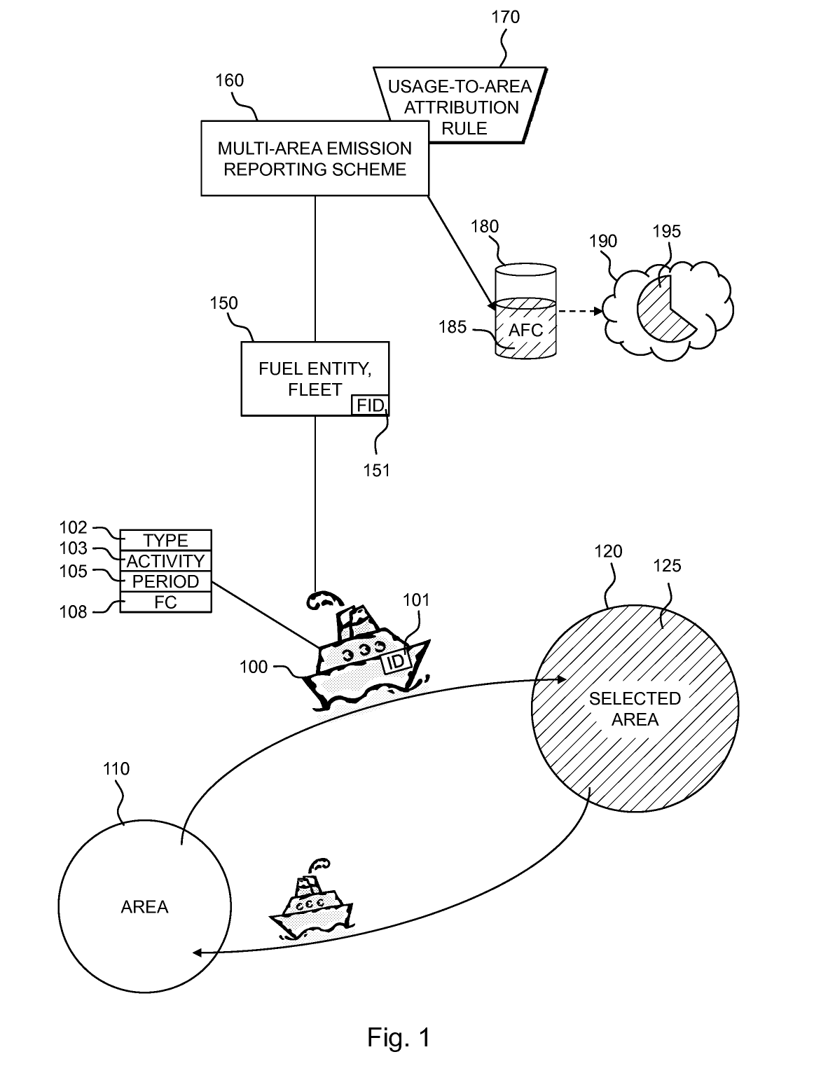

### DETAILED DESCRIPTION—FIRST EMBODIMENT—FIGS. 1-3

### Key Terms and Scope

In the description of the preferred embodiments of the present invention several specific terms are used. Their definitions follow.

The term “vehicle” denotes a mechanical vehicle, such as a ship, an aircraft, a car, a bus, a van, a coach.

The term “fuel entity” is defined as an entity that has access to data on fuel consumption of one or more vehicles, and will report the data. Each of the following may be a fuel entity: an aircraft operator, a ship manager, a fuel supplier, the ship itself.

The term “fleet” is defined as the fuel entity registered with the scheme provided by the embodiments of the present invention.

The term “area” is defined as a geographical area, such as a country, group of countries, and similar. The term “selected area” denotes any area for which reporting is required and provided.

The term “usage-to-area attribution rule” (UTA rule) is defined as a rule that attributes or apportions usage of vehicles to areas they serve. In the embodiments of the present invention, UTA rules generally are defined to reflect the responsibility of end customers or consumers from the selected area for emissions from services provided by vehicles. For instance, a country's share of global imports is a suitable UTA rule, as it reflects or proxies the country's share of responsibility for emissions from international transport. This is because a country's usage of international transport is closely related to its imports.

The term “attributed fuel consumption” is defined as the fuel consumption that is attributed to an area, for each type of fuel used.

The term “emissions” is limited to emissions from fuels used by vehicles. Emissions from production, repair and disposal of the vehicles are excluded.

The term “attributed emissions” is defined as the quantity of emissions that is attributed to an area.

I will describe embodiments for reporting fuel consumption and carbon dioxide (CO2) emissions from vehicles. Embodiments to report emissions from a predetermined list of greenhouse gases (GHGs), are essentially the same. They are derived by substituting CO2 emissions with carbon-dioxide equivalent (CO2e) emissions, using established industry practices. Embodiments for reporting other emissions which relate to fuel consumption can be easily derived in a similar way.

### Key Elements—FIG. 1

FIG. 1 illustrates the above key terms and elements that will be used throughout the application. The lower part of FIG. 1 shows: a vehicle 100 with a vehicle identifier (ID) 101, and with further characteristics of a type 102, an activity 103, a period 105, and fuel consumption (FC) 108. It also shows two exemplary areas 110 and 120, between which vehicle 100 carries its activities. The upper part of FIG. 1 illustrates: a fuel entity, fleet 150 with a fleet identifier (FID) 151, a multi-area emission reporting scheme 160, and an associated usage-to-area attribution (UTA) rule 170. It further illustrates results: total fuel consumption (TFC) 180, and attributed fuel consumption (AFC) 185, as well as total emissions 190, and attributed emissions 195.

Vehicle 100 is shown as ship, but it may be a ship, an aircraft, or another vehicle. ID 101 uniquely identifies vehicle 100. It is typically the vehicle registration number. Preferably ID 101 uses global standards for vehicle registrations, such as the IMO number for ships, and ICAO 24-bit address for aircraft. Type 102 is associated with vehicle 100 and typically is the vehicle type, such as passenger or cargo vehicle. Activity 103 defines activity that is subject to emission reporting. If not defined, all activities of vehicle 100 are included. Period 105 is a time-frame.

FC 108 is fuel consumption of vehicle 100 for activity 103 over period 105. FC 108 typically equals an amount of fuel combusted. In some embodiments it is obtained as an amount of fuel delivered to vehicle 100. If more than one type of fuel is used, FC 108 refers to consumption of each type of fuel separately. In such a case TFC 180 and AFC 185, described below, also refer to consumption of each type of fuel separately.

Areas 110 and 120 are the areas between which vehicle(s) 100 operate, as illustrated by the arrows. Reporting of fuel consumption attributable to at least one area is to be provided by embodiments of the present invention. This reporting area is called a selected area. For illustration area 120 is shown as selected area, and denoted with a numeral 125, as selected area 125.

Although not illustrated, vehicle 100 can also operate within areas 110 and 120. It can also operate between the areas 110 and 120 without actually arriving in any of them. For instance, it may be a part of chain of vehicles transporting goods between the areas by carrying the goods from one off-shore location to another, somewhere between the areas 110 and 120 (not shown). These off-shore locations are often used for trans-shipment of goods.

Fuel entity 150 is typically accountable for FC 108, and for emissions from it (as illustrated). The same entity may be accountable for, or administer emissions from, other vehicles of type 102, and potentially other types. In embodiments of the present invention, fuel entity 150 becomes or is started to be called a fleet 150 once registered with scheme 160. When registered, fleet 150 is identified in scheme 160 by a unique fleet identifier (FID) 151.

The multi-area emission reporting scheme 160 is the subject of embodiments disclosed herein, including system and methods. UTA rule 170, which is an important element of these embodiments, is further described below.

TFC 180 represents total fuel consumption from all vehicles in scheme 160, including FC 108. It is for a given period of time, called attribution period (not shown). AFC 185 represents part of TFC 180 that is attributed to selected area 125. It is calculated and reported by scheme 160. AFC 185 is calculated in relation to UTA rule 170.

Total emissions 190 is the quantity of emissions from TFC 180, while attributed emissions 195 is the quantity of emissions form AFC 185. They are optionally calculated and reported by scheme 160.

With continuing reference to FIG. 1, a prerequisite for calculating and reporting of AFC 185 is the definition of relevant entities and scope parameters. They are areas 110 and 120, at least one selected area 125, vehicles 100, fuel entities 150, and UTA rule 170. The attribution period needs also be specified. For instance, it may be defined as one year, or any other time value or frequency.

Value for period 105 for which FC 108 is to be reported may be recommended or defined, for instance as a month. Furthermore, vehicle type 102 and activity 103 may be defined, specifically when only some vehicle types and activities are to be included. Alternatively, type 102 and activity 103 may be used for granularity of reporting. In such case, UTA rule 170 may even be defined in relation to type 102 and activity 103. Once the parameters are defined, the overall process to obtain AFC 185 is as follows.

Each fuel entity 150 registers with scheme 160, and becomes or is called from then a fleet 150. The registration establishes a fleet account within scheme 160 identified by FID 151 (not shown). It may establish or provide for authorized connectivity between fleet 150 and scheme 160. Furthermore, accounts for each vehicle 100 are created, if they have not been available in scheme 160 yet (not shown). Each vehicle account is identified by unique ID 101 identifying vehicle 100.

Periodically, fleet 150 submits FC 108 to scheme 160, for every vehicle 100 it is accountable for. FC 108 is accompanied by ID 101 and an actual value of period 105. It may also be accompanied by type 102 and activity 103. Similar submissions are done by, or on behalf, of other fleets. Scheme 160 aggregates FC 108 from all vehicles 100 into TFC 180, over the attribution period. Subsequently, it calculates AFC 185 for selected area 125, from TFC 180 according to UTA rule 170. Optionally, total emissions 190 are calculated from TFC 180, and attributed emissions 195 from AFC 185. Finally, a report with at least AFC 185 or attributed emissions 195 is produced. The report may include ID 101 for each vehicle 100 covered by AFC 185.

FIG. 1 is illustrative with only two areas shown, 110 and 120. Given that the areas are typically defined as countries, their number is typically much larger than two. In such embodiments vehicle 100 is typically engaged in international transport. Vehicle 100 may also be replaced in FIG. 1 by a group of vehicles, for instance all aircraft operated by an airline.

I will now describe in more detail UTA rule 170 as an important element of embodiments of the present invention. It will be followed by a preferred embodiment for scheme 160, including system and methods.

### UTA Rule 170

As defined in this application, UTA rule 170 generally reflects the responsibility of end customers in an area for a share of emissions from services provided by vehicles. This implies that UTA rule 170 is unrelated to the current way of attributing emissions, in which vehicle emissions are attributed to a country, or area, of fuel sale. Therefore, in preferred embodiments, UTA rule 170 is unrelated to country of fuel sale or purchase, and thus unrelated to the amount of fuel purchased in the country, and similar. It is also unrelated to the amount of fuel consumed in the country, or area. Generally, UTA rule 170 is also unrelated to other traditional approaches based on country of: vehicle registration, vehicle owner, departure port, and arrival port. None of these traditional approaches adequately reflects the responsibility of end customers of international transport, or transport generally.

UTA rule 170 is preferably defined through a statistical measure that reflects or proxies the responsibility of end customers in an area for emissions from vehicles serving that area. Table 1 illustrates selected UTA rules 170, with their preferred applicability for predominantly transport or travel embodiments.

TABLE 1
Sample usage-to-area attribution (UTA)
rules and preferred applicability

| UTA rule | Preferred Applicability |
|---|---|
| An area's share of imports | Transport |
| Share of passengers resident in and traveling to | Travel |
| and from an area | |
| An area's share of imports | Transport and Travel |
| A weighted share of separate transport and | Transport and Travel |
| travel UTA rules (as above or similar) | |

Each UTA rule 170 can just be the best readily available proxy, under given circumstances. For instance, the area's share of imports is shown in Table 1 as one preferred option for embodiments encompassing both transport of goods and passenger travel. A country's share of global imports is readily available, for instance from the International Monetary Fund (IMF). Albeit the country's share of imports is not directly related to passenger travel, it takes advantage of the correlation between imports and travel. Residents of countries that import a lot typically also travel a lot.

Each rule has a variety of ways in which its application can be measured. For instance, an area's share of imports is typically measured in terms of value. But it may also be measured by volume, value-distance, volume-distance, and the like. The rule may be defined for a specific mode of transport or travel, or for all vehicles. For instance by relating to seaborne imports, airborne imports, traveling by air, or jointly to seaborne and airborne imports, and similar. The rule may also be based on exports, trade, or weighted imports and exports, and similar.

Certain measures may require compilation of data from different sources. For instance, to obtain a country's share of imports by value-distance, the following compilation may be used. Data for country imports by value, by exporting country, is obtained from the IMF, or the United Nations Commodity Trade Statistics Database, or similar. Data on average distances between different countries may be obtained from variety of sources, including CEPPI, the French Center in International Economics. For shipping, nautical distances between main ports may be used. The selected data sources for imports and distances are combined to produce share of imports by value-distance. Other formulas may be used, for instance to calculate a share of imports by sea and air.

In a variant of the compilation above, data on actual distances traveled may be used. Such data can be obtained from vehicle tracking systems such as the Automatic Identification System (AIS) for shipping, or radar information for aircraft. Advantageously, this approach would capture changing transport patterns. For instance using AIS would automatically include shorter shipping routes such as the Northern Passage, once they become operational.

In some embodiments UTA rule 170 is applied on enterprise level, for instance to emissions from ships operated by a shipping company. Table 2 illustrates selected enterprise-level UTA rules 170, with their preferred applicability for predominantly transport or travel embodiments.

TABLE 2
Sample enterprise UTA rules and preferred applicability

| UTA rule | Preferred Applicability |
|---|---|
| Share of goods carried to an area | Transport |
| Share of passengers carried resident in or | Travel |
| citizen of an area | |
| A weighted share of separate transport and | Transport and Travel |
| travel UTA rules (as above or similar) | |

While being novel, the use of UTA rule 170 in a top-down manner makes equitable attribution of emissions from international transport viable. Although not fully described yet, it also enables the creation of market-based emission reduction schemes acceptable to countries at different stages of economic development. Selected UTA rules will be described in more detail below for example embodiments. The description of the preferred embodiment follows.

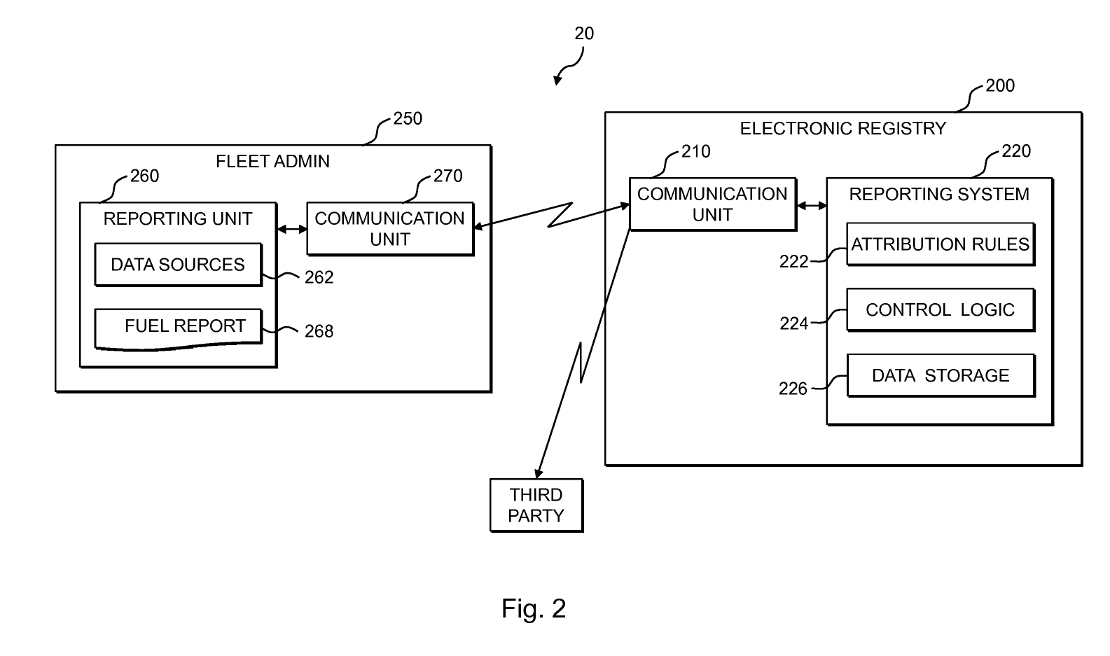

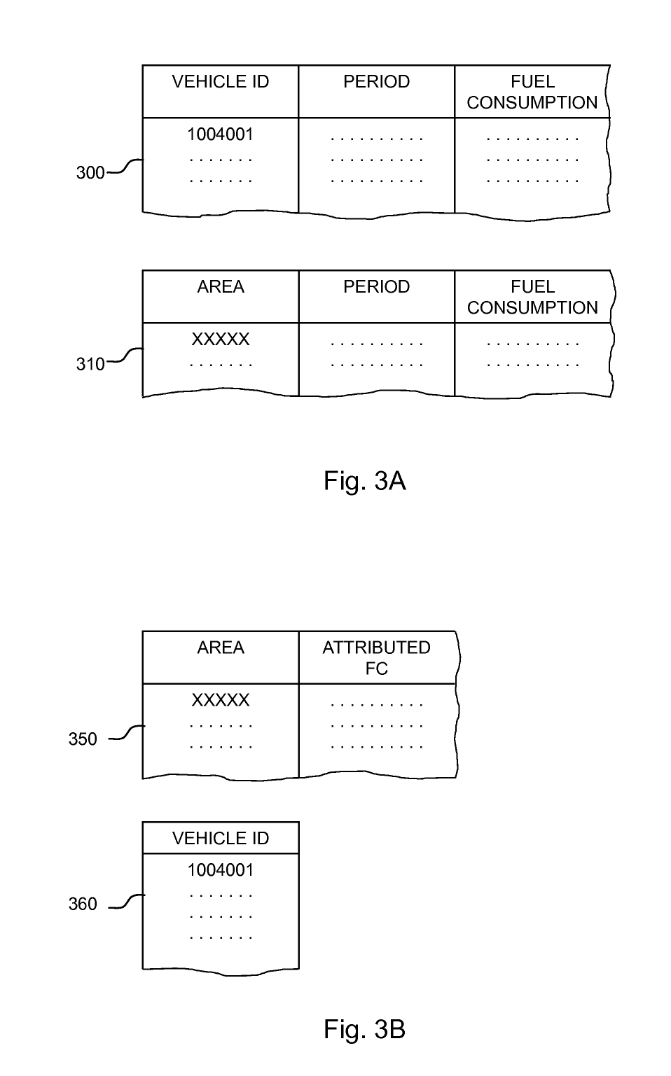

### 1. Preferred Embodiment of Multi-Area Emission Reporting System 20—FIGS. 2-3

FIG. 2 illustrates a block diagram of the multi-area emission reporting system for vehicles 20. System 20 nominally includes an electronic registry 200 and a number of fleet admin units 250, one per each fleet. System 20 is the underlying technical part of embodiments of scheme 160, outlined above. Therefore, previous technical references to scheme 160 should be understood as references to system 20.

### Electronic Registry 200

Electronic registry 200 includes a communication unit 210 and a reporting system 220. Reporting system 220 includes attribution rules 222, control logic 224 and data storage 226.

Attribution rules 222 provide definitions and operational functions for UTA rule 170, and similar. By way of specific example, in one embodiment attribution rules 222 include a look-up table for a country share of global imports, in a given year. In such an embodiment, areas are defined as countries.

Control logic 224 analyzes data received through communication unit 210 and data stored in data storage 226 for determining an appropriate course of action. The actions include: registering a fuel entity as fleet 150, opening a new fleet account for fleet 150, opening a new account for each vehicle 100, and storing a fuel report 268 into data storage 226. The actions further include: creating a report for a fleet 150 from data recorded in data storage 226, creating a report for vehicle 100, creating a report for selected area 125 by using attribution rules 222, and creating combined reports for areas, fleets, and vehicles.

By way of specific example, the control logic 224 may be a computer, such as the Hewlett Packard workstation model HP Z600.

Data storage 226 stores fuel consumption and other information that reporting system 220 uses. Specifically, fuel consumption data is stored and updated according to the data received from fleet admin 250, and similar. Reporting system 220 uses data already stored for validating fuel reports received from fleet admin 250, and for producing its reports. System 220 can also use information stored in data storage 226 to provide compliance verification of vehicles 100 and fleets 150 with an emission regime in force.

Information stored in 226 is organized through data structures such as accounts, lists, and similar. Accounts are for vehicles, fleets, areas, and similar. Lists are for area names, vehicle types, vehicle activities, selected areas, and so on. Accounts are identified by their relevant unique identifiers, such as ID 101 and FID 151, for vehicles and fleets respectively. In the preferred embodiment vehicle fuel consumption data is recorded only in the vehicle account, in order to guarantee data integrity in a complex system. In some embodiments, fuel consumption reported through additional data is stored in area accounts, identified by their unique names or identifiers.

Data relationships between vehicles 100 and fleets 150 are established, thereby allowing for a variety of queries and reports per fleet and vehicle.

By way of specific example, the data storage 226 may be an open source database mySQL version 5.1, or a commercial Oracle database version 11g. Both deliver the scale and performance for large implementations envisaged by embodiments of the present invention. The large implementations are defined by tens of thousands of fleets and vehicles, potentially two hundred countries, and millions of records anticipated in several embodiments.

With continuing reference to FIG. 2, the communication unit 210 allows registry 200 to communicate with fleet admin 250, and similar. Preferably, unit 210 communicates with fleet admin 250 via the Internet or a similar electronic connection. In each case, authenticated communications are preferred for receiving data from fleet admin 250.

Additionally, unit 210 may communicate with third parties interested in receiving reports from registry 200. In one embodiment, communication unit 210 sends email messages over the Internet to third parties, such as government authorities responsible for reporting emissions from transport.

In another embodiment, unit 210 sends messages responding to compliance verification requests from authorized agencies, such as port authorities. These messages confirm or refute compliance of vehicle 100 with the emission reporting obligations, based on data from the vehicle account. In yet another embodiment registry 200 creates a black list of vehicles not complying with the emission reporting obligations. This black list is distributed by unit 210 to organizations promoting safe and responsible transport, such as the eQuasis in shipping.

### Fleet Admin 250

Fleet admin 250, as shown in FIG. 2, includes a reporting unit 260 and a communication unit 270. Fleet admin 250 prepares and submits fuel consumption data for each vehicle 100 in fleet 150, to registry 200.

Reporting unit 260 has access to and uses data sources 262 to prepare a fuel report 268, for a given attribution period. By way of specific example, one data source 262 is an Operations Management System (OMS) used by aircraft operators. An example from shipping, are fuel receipts or their computerized records. Fuel receipts, called Bunker Delivery Notes, are obligatory in shipping mandated by MARPOL convention, in Annex VI. Yet another example of data source 262 is the Oil Record Book, kept on board of practically each ship.

Reporting unit 260 prepares fuel report 268 using data sources 262 through their procedures that may be manual, electronic, or fully automatic. For instance, for the majority of aircraft operators, the data required for fuel report 268 can be automatically extracted from data sources 262, such as the aforementioned OMS.

Fuel report 268 contains a very limited amount of data. In preferred embodiment report 286 comprises FC 108, ID 101, and period 105, for each vehicle in fleet 150. In some embodiments, report 268 contains additional data providing fuel consumption associated with each selected area, for a specific activity 103 of all fleet vehicles. This additional data is illustrated later in FIG. 3A.

With continuing reference to FIG. 2, fleet admin 250 communicates with registry 200 through its communication unit 270. Specifically, communication unit 270 submits fuel report 268 to registry 200, as often as required. In one embodiment the submittal is through a spreadsheet file created from a template provided by registry 200. For electronic and fully automatic embodiments the use of open standards is preferred, such as the Extensible Markup Language (XML).

Furthermore, the submission of fuel report 268 by communication unit 270 preferably occurs only after a successful authentication of communication units 210 and 270 by each other. The necessary credentials are established at the time of fleet registration with registry 200. By way of example, the credentials may include user passwords, hardware authentication keys, or both. As an example, the RSA SecurID tokens may be used for the hardware authentication keys. I now describe example data for fuel report 268, as well as example output data from system 20 (not shown).

### Example Data

FIGS. 3A-3B illustrate representative input and output data for system 20.

FIG. 3A shows main data 300 and additional data 310 as used in the preferred embodiment for submitting fuel consumption in system 20.

Main data 300 illustrates main content for fuel report 268 by fleet admin 250, as described above. It advantageously comprises only of vehicle ID, period, and fuel consumption for each vehicle in the fleet. Main data 300 is preferably accompanied by a data header (not shown). In the preferred embodiment the data header comprises FID 151, as well as type 102 and activity 103, when they are used to categorize vehicle data submitted. In other embodiments further identification or other data may be included.

Additional data 310, as used in some embodiments, comprises of area, period, and fuel consumption, for all vehicles in the fleet covered by the report. An example embodiment that takes advantage of additional data 310, by incorporating fuel consumption for domestic flights in aviation, is discussed later.

FIG. 3B illustrates output or report records from system 20. It comprises a main record 350 and an optional record 360, obtained by transforming input data described above.

Main record 350 includes area and attributed fuel consumption, for each selected area 125. Additionally, main record 350 is preferably accompanied by a data header (not shown). In the preferred embodiment the data header comprises type 102 and activity 103, as appropriate. Further identification or other data may be included.

Optional record 360 provides a vehicle list, including ID of each vehicle covered by main record 350. It may include other identification details, as well as further information.

FIGS. 3A-3B also demonstrate the transformational character of embodiments of present invention. They transform data 300, and optionally 310 into currently unavailable records 350 and 360, through the use of system 20 and methods disclosed herein. This transformation is delivered for a large number of vehicles, which reach tens of thousands in some embodiments. Such transformation cannot be achieved through manual or other existing approaches.

Advantageously, in embodiments of the present invention only data that is readily available is required. Furthermore, the data is required in limited quantity, as illustrated in FIG. 3A. In the preferred embodiment, essentially only fuel consumption per vehicle, FC 108, is required, for instance annually. Details per vehicle voyages or fleet routes are not required. In contrast, the planned reporting of aviation emissions within the EU ETS requires complex details, albeit at fleet level. There, reporting of emissions by both origin and destination of flights is required, as well as passengers and cargo mass per each aerodrome pairs served.

Thus this embodiment provides a novel system for reporting attributed fuel consumption or attributed emissions from vehicles operating between different areas. Each fleet admin 250 submits a limited number of fuel reports to electronic registry 200. These reports provide fuel consumption per each vehicle that can be easily validated through the vehicle identity provided. Fuel consumption from all vehicles is aggregated by registry 200 and attributed to the selected area or areas. The attribution to any area is obtained through the user-to-area attribution rule (UTA rule 170).

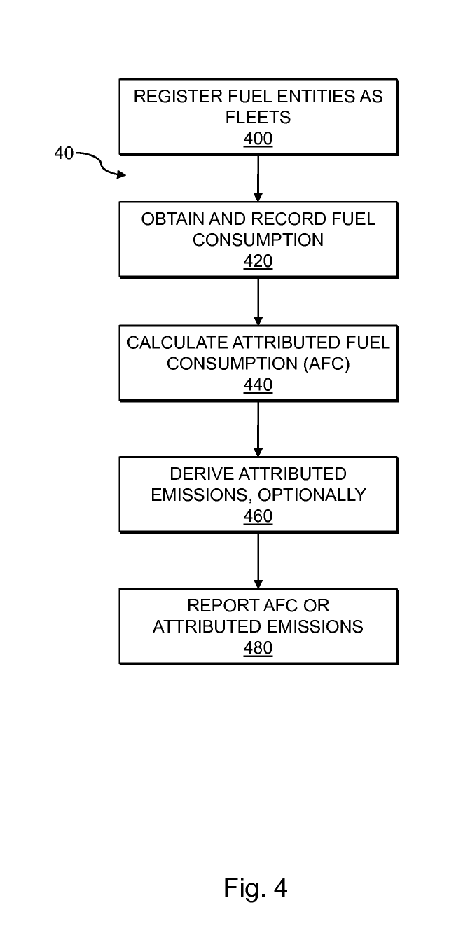

### Operation—First Embodiment—FIG. 4

The operation of a first, general embodiment of the multi-area emission reporting system 20 will be described in detail with reference to FIG. 4.

As embodied herein, the method 40 comprises registering fuel entities as fleets 400, obtaining and recording fuel consumption 420, calculating attributed fuel consumption 440, optionally, deriving attributed emissions 460, and reporting attributed fuel consumption or attributed emissions 480. The steps are described using previously introduced elements of system 20 (FIG. 2) and key terms (FIG. 1).

### Registering Fuel Entities as Fleets 400

In step 400, each fuel entity is registered by electronic registry 200, becoming a fleet 150 in the process. Registry 200 establishes a unique FID 151 for fleet 150 and creates a new fleet account in data storage 226. The new account is identified by FID 151.

Registry 200 also creates and delivers electronic credentials for fleet admin 250, in order to establish authenticated communications between the two.

Preferably, registry 200 also provides instructions and templates to fleet admin 250 for submitting fuel reports. By way of example, the reporting template may be a spreadsheet template with a layout similar to the one shown in FIG. 3A. The template preferably employs various validation techniques in order to avoid entry of incorrect data and to enable automatic or semi-automatic import of submitted data to registry at a later stage.

As part of this registration step, vehicle accounts may be established by registry 200 for each vehicle 100 in fleet 150. For instance, fleet admin 250 may provide a registration list of its vehicles each identified by ID 101. In response to this, registry 200 creates a vehicle account in data storage 226 for each new ID 101, and links it to the fleet account identified by FID 151.

### Obtaining and Recording Fuel Consumption 420

In step 420, registry 200 obtains fuel reports from each fleet admin 250. These fuel reports are checked and stored in data storage 226. For a given fleet admin 250 preferably the following is performed.

Registry 200 obtains fuel report 268 from fleet admin 250, preferably through an authenticated communication exchange between communication units 270 and 210. In some embodiments the exchange may be further encrypted for confidentiality. Regarding data itself, report 268 is preferably obtained as an electronic document. The electronic document may be a structured file, preferably using open standards such as the XML.

After receiving fuel report 268, control logic 224 typically validates it for correctness. As described, fuel report 268 contains FC 108, period 105, and ID 101, for each vehicle in fleet 150, as managed by fleet admin 250. Value of period 105 may vary from vehicle to vehicle, and from report to report, as it is the actual timeframe for which FC 108 is reported. For instance, period 105 variability would be likely, when fuel report 268 is for a defined number of voyages, fuel purchases, or similar events. Fuel report 268 also contains FID 151, and may contain further details. These may be included in the report's header. The following sequence of checking and recording FC 108 is repeated for each vehicle in fuel report 268.

If fuel report 268 is judged correct by control logic 224, its content or part of it is recorded. FC 108, period 105, and FID 151 are recorded in data storage 226 in the vehicle account identified by ID 101, for each vehicle in fuel report 268. Furthermore, content of the header of report 268 is typically recorded also, for each vehicle. For instance, such header may include type 102, and activity 103, in addition to FID 151. Operationally, to store the data, typically a new record is created in the vehicle account. Preferably, this record is linked back to fleet account identified by FID 151. If required vehicle account with ID 101 does not exist yet, it is created for immediate use.

If fuel report 268 is judged incorrect by control logic 224, communication unit 210 sends a request for report correction to fleet admin 250 through their communication unit 270.

Various checks may be performed by control logic 224. They include validity checks for ID 101, period 105, and FC 108. Checks for double reporting may be made by comparing period 105 with reports already stored in vehicle account identified by ID 101.

Furthermore, the value of FC 108 can be cross-checked or validated. Control logic 224 can validate it with fuel data provided by third parties or with fuel consumption estimates, within period 105. By way of example, fuel consumption estimate for a given aircraft can be calculated by the Pagoda tool provided by the European Organization for the Safety of Air Navigation.

Potential for quantity validation, enabled by the vehicle-level reporting approach, is an advantage of embodiments of the present invention. It increases accuracy and compliance, as incorrect reporting can be easily detected. Furthermore, it can entirely eliminate or significantly reduce the need for employing emission verifiers. These provide scalability and a significant reduction of operational costs. Thus, embodiments of the present invention are suitable to global deployment for international transport.

### Calculating Attributed Fuel Consumption (AFC) 440

With continuing reference to FIG. 4, in step 440 attributed fuel consumption (AFC) 185 is calculated by reporting system 220. AFC 185 is for selected area 125, over the attribution period. More specifically, control logic 224 calculates AFC 185 from total fuel consumption (TFC) 180 and usage-to-area attribution (UTA) rule 170. TFC 180 itself is calculated as described below.

Generally TFC 180 and AFC 185 are calculated in relation to provided criteria. The criteria include the attribution period, type 102, activity 103, and similar. Control logic 224 calculates TFC 180, preferably through database queries implemented within data storage 226. These queries select and aggregate all relevant values of FC 108 recorded in vehicle accounts, as per provided criteria.

In some embodiments, control logic 224 may scale up or down, or fill gaps in FC 108 data in order to calculate TFC 180. For instance, for a given vehicle only data for three quarters may have been reported so far. When the attribution period spans an entire year, control logic 224 may estimate fuel consumption for the final quarter for this given vehicle.

Subsequently to calculating TFC 180, control logic 224 calculates AFC 185, for one or more of selected areas 125. It calculates AFC 185 from TFC 180 and attribution rules 222, which provide relevant UTA rule 170. Both TFC 180 and AFC 185 may be stored in data storage 226, together with the criteria used to calculate them. Alternatively, they may be obtained dynamically as needed through the database queries.

### Deriving Attributed Emissions, Optionally 460

With continuing reference to FIG. 4, in step 460, total emissions 190 and attributed emissions 195 may be derived by control logic 224. This step is optional as these emissions can be easily derived from TFC 180 and AFC 185, respectively. Emissions are derived from fuel consumption and a predetermined emission factor (EF), for each fuel. The following standard formula is preferred: emissions=fuel consumption×EF.

As known in industry, EF depends on type of fuel and emissions considered. For instance, EF for CO2 expresses how much CO2 emissions is embedded or generated from one unit of fuel. These factors do not change materially between different grades of the same fuel. Therefore a standard or average value for each relevant EF is typically stored in data storage 226, and used consistently for all calculations.

Table 3 illustrates average CO2 emission factors for major fuel types used in aviation and maritime transport.

TABLE 3
CO2 emission factors for selected fuels

| Fuel type | EF (t/t) |
|---|---|
| Aviation Jet Kerosene (Jet A1/A) | 3.15 |
| Aviation Gasoline (AvGas) | 3.10 |
| Marine Heavy Fuel Oil (HFO) | 3.13 |
| Marine Diesel Oil (MDO) | 3.19 |

If more than one type of fuel is used, emissions for each type of fuel are calculated. They may be later reported per fuel type. Alternatively, these emissions may be summed up to provide aggregated emissions from all types of fuel used.

In such case total emissions 190 and attributed emissions 185 relate to emissions from all types of fuel used by vehicles 100.

### Reporting AFC, or Attributed Emissions 480

With continuing reference to FIG. 4, in step 480 AFC 185 or attributed emissions 195 for selected area(s) 125 are reported. Additionally, a list of all vehicles covered by the result may be reported, including ID 101 of each vehicle. This may be reported in format previously illustrated on FIG. 3B. Total fuel consumption 180 and total emissions 190 may also be reported.

If more than one type of fuel is used, aggregated emissions from all of them may be reported. In such a case, total emissions 190 and attributed emissions 195 provide aggregated single values. In other embodiments, emissions 190 and 195 may be reported by each type of fuel used. Such reporting would mirror fuel reporting, by type of fuel.

From the system point of view, the report is prepared by control logic 224 from information recorded in data storage 226. The report is distributed to interested parties by communication unit 210, preferably using electronic methods. In one embodiment the report is distributed by email to registered addresses of interested parties stored in data storage 226. The interested parties typically include government organizations of selected area(s) 125, multi-area organizations, and alike. The reports, or relevant extracts, are also typically distributed or made available to each of fleet admin 250.

In some reports ID 101 of covered vehicles may not be provided, but they can be queried through communication unit 210 of registry 200, for instance for validation and enforcement purposes. The querying may be restricted to fleet admin 250 and other authorized third parties.

Identifying vehicles covered by AFC 185, or attributed emissions 195, through their ID 101 is advantageous for compliance reasons. It enables easy tracking of vehicles covered by the report or generally by system 20.

The novel application of UTA rule 170 together with vehicle-level reporting provides a concrete, accurate, and useful result. The major advantage is the correct attribution of vehicle emissions to the different areas. The emissions are attributed in relation to the demand of end customers or consumers from these areas. This is most appropriate, as it is the demand for transport or travel services from these end customers that causes the fleet activities.

The novel approach is thus useful, and contrasts with the current situation where emissions from international transport are reported to the UNFCCC based on amount of international fuel sold in a country. The current situation has been judged unreasonable, especially for international shipping. For instance, the United Kingdom (UK) imports approximately 5% goods globally but sells less than 1% of fuel to ships engaged in international transport. Such issues also lead to an incorrect but widely-held view that emissions from international transport cannot be accounted or attributed towards particular economies. The first, general embodiment of the present invention resolves these significant difficulties and is illustrated by an exemplary country result.

### Exemplary Country Result

With continuing reference to FIG. 4, the exemplary country result refers to what would have been the outcome of method 40 if the above embodiment was applied to international shipping. The entities and scope are assumed as follows. Vehicles 100 comprise all ships active in international maritime transport at or above a predetermined size threshold. The size threshold is established as 400 gross tons (400 GT). The number of ships of that size is approximately 40 thousand. Areas are defined as countries. Selected area 125 is the UK. Attribution period is defined as year 2005. Vehicle emissions are carbon dioxide emissions. UTA rule 170 is defined as a country's share of global imports, by value. FC 108 is the amount of fuel purchased in 2005, as recorded in the compulsory fuel receipts.

The embodiment would have produced TFC 180 of approximately 195 million tons (Mt) of Marine Heavy Fuel Oil (HFO), and 58 Mt of Marine Diesel Oil (MDO). These estimates are from the International Maritime Organization (IMO), and quantify what would have been produced by obtaining fuel consumption in the bottom-up step 420. In step 440 AFC 185 is calculated, for each fuel type. Given that the UK's share of global imports was 4.8% in 2005, AFC 185 for the UK in 2005 equal 9.4 Mt HFO (4.8%×195), and 2.8 Mt MDO (4.8%×58).

The procedure of steps 460, with CO2 emission factors for HFO and MDO from Table 3, produces estimate of total emissions of 795 Mt CO2. The basic calculation is: total emissions=195×3.13+58×3.19=795. By applying the above UK's share of global imports of 4.8%, attributed emissions 195 for the UK in 2005 are derived as approximately 38 Mt CO2 (4.8%×795).

The example result clearly demonstrates one advantage. The embodiment can easily and precisely account for country emissions in relation to the end user responsibility for transporting goods to the country, expressed by UTA rule 170. The embodiment is not obvious as such top-down attribution approach combined with bottom-up collection of fuel consumption data has never been proposed before.

Furthermore, it provides a clear advantage over the current approach to account for international emissions based on the quantity of fuel sold in a given country. In the UK very little fuel is sold for ships, for commercial and logistics reasons. The fuel-based estimate of the UK's share of international shipping emissions is 6.9 Mt CO2 for 2005, as reported to the UNFCCC. It is nearly six times lower than the calculation of 38 Mt CO2 as per the exemplary result. For some other countries, such as the Netherlands and Singapore the correction applies the other way, as they sell disproportionably large quantities of fuel for ships.

### Exemplary Enterprise Embodiment

The preferred embodiment can also apply at a smaller, enterprise scale, rather than at the global or country level.

The following describes an exemplary embodiment for reporting attributed emissions 195 by an enterprise, such as a shipping company or aircraft operator. For instance, attributed emissions 195 may be needed for the enterprise to comply with a national, regional or international legislation on GHG reporting, or similar.

For simplicity I define only two areas, as introduced in FIG. 1. Area 120 is a given country or a geographic region, area 110 is rest of the world. Area 120 may be discontinuous, for instance it may comprise all developed countries in which case area 110 would comprise developing countries. It may also comprise countries and territories subject to the same jurisdiction or legislation, and so on.

Vehicles 100 are ships of a predetermined type 102 used by the enterprise. Fuel entities 150 are ship managers or operators, each managing one or more of vehicles 100. A small enterprise may be the ship manager itself. Only ships active in international shipping of 400 GT or more are included. Attribution period is assumed to be one year, but could be defined otherwise. FC 108 is defined as fuel purchased, as recorded in ship's fuel receipts, in period 105. Period 105 is typically equal to or smaller than attribution period. For illustration period 105 is assumed to be a month.

Ship managers may also be understood or defined as entities responsible for compliance of ships. In shipping such an entity is called Document of Compliance company, and is identified by its unique IMO company number.

UTA rule 170 is defined as a share of volume of cargo carried to an area. The carrying to is based on final destination of the cargo. When final destination of cargo is unknown, the area where it is unloaded is treated as the final destination. Cargo may refer to goods and passengers.

The volume of cargo is expressed in a predetermined measure, appropriate to type 102. For many ship types this is the cargo mass. For ships that are volume constrained different measures are preferred. For instance, for container ships the preferred measure is the number of full (not empty) containers carried, expressed in TEU units. TEU is the volume of a twenty-foot long standard-size container. For passenger ships, the preferred measure is the number of passengers carried. Preferred measures of volume of cargo for different ships are summarized in Table 4.

TABLE 4
Volume of cargo measures for different types of ships

| Ship type | Volume of cargo measure |
|---|---|
| Bulk carrier | Mass of cargo |
| Tanker | Mass of cargo |
| General cargo ship | Mass of cargo |
| Container ship | Number of full containers (TEU) |
| Combination cargo ship | Mass of non-containerized cargo + |
| | Number of full TEU × 10 tons |
| Vehicle carrier-ferry | Number of car units |
| Passenger ship | Number of passengers |

FIG. 4 is reused to illustrate operations of this example embodiment. In step 400 the fuel entities for vehicles 100 are registered as fleets 150, with each fleet having fleet admin 250 for providing fuel reports. Electronic registry 200 is operated by or on behalf of the enterprise.

In step 420, fuel consumption reports are obtained by registry 200 from each of fleet admin 250, over the attribution period. The reports include FC 108 for each vehicle 100. Based on the illustrative assumptions, each of fleet 250 is expected to submit twelve monthly fuel consumption reports for the attribution period of one year.

In step 440, AFC 185 is calculated by registry 200. First TFC is calculated from FC 108 for all vehicles 100, for the attribution period. To apply UTA rule 170 the share of cargo carried to selected area 125 by the enterprise is obtained. The value is obtained by repository 200 typically from the enterprise statistics or records. Subsequently, AFC 185 is calculated by multiplying TFC 180 by the share of cargo carried to selected area 125.

In step 460, attributed emissions 195 are derived from the AFC 185 by applying relevant emission factors.

In step 480, registry 200 reports AFC 185 or attributed emissions 195 for selected area 125. The report format illustrated in FIG. 3B may be used.

The enterprise example demonstrates another advantage of embodiments of the present invention. Method 40 and system 20 can be applied with bottom-up accuracy in order to precisely calculate attributed emissions from carrying goods to selected area 125, from vehicles used by the enterprise. The aggregated approach reduces the data needs regarding volume and destinations of cargo, as these are needed only over the entire attribution period. It also reduces commercial sensitivity as aggregate statistical data is used rather than data on cargo delivered by individual vehicles. The description on volume of cargo measures, as provided in Table 4, discloses how the diversity of ships is addressed.

The usage of the final destination of cargo in calculating attributed emissions adds to the novelty of the example embodiment. Final destination has not been used to account for international transport emissions, to the best knowledge of the Applicant. Yet, together with method 40 disclosed, it can effectively and fairly account for transport emissions between areas. In many cases, goods are unloaded not at the final destination or area, but are carried there by other vehicles. In shipping this typically includes trans-shipments and feeder vessels, and may include overland vehicles. Thus, this approach allows to equitably account for emissions from international maritime transport also to land-locked countries, such as Switzerland, a significant importer of goods.

Advantageously, the above-described multi-area emission reporting system 20 and method 40 may be applied in many different ways both at the enterprise and country levels. They may be applied for reporting emissions from aircraft, ships, and other vehicles. The attributed emissions 195 can then be incorporated in the national emission totals or budgets. Thus, embodiments of the present invention can resolve a long-standing problem of accounting for emissions from international transport.

Below are the second, third, fourth, fifth, and sixth embodiments of the multi-area emission reporting system 20. They use the same system components as described above, but include additional steps to accomplish each respective function.

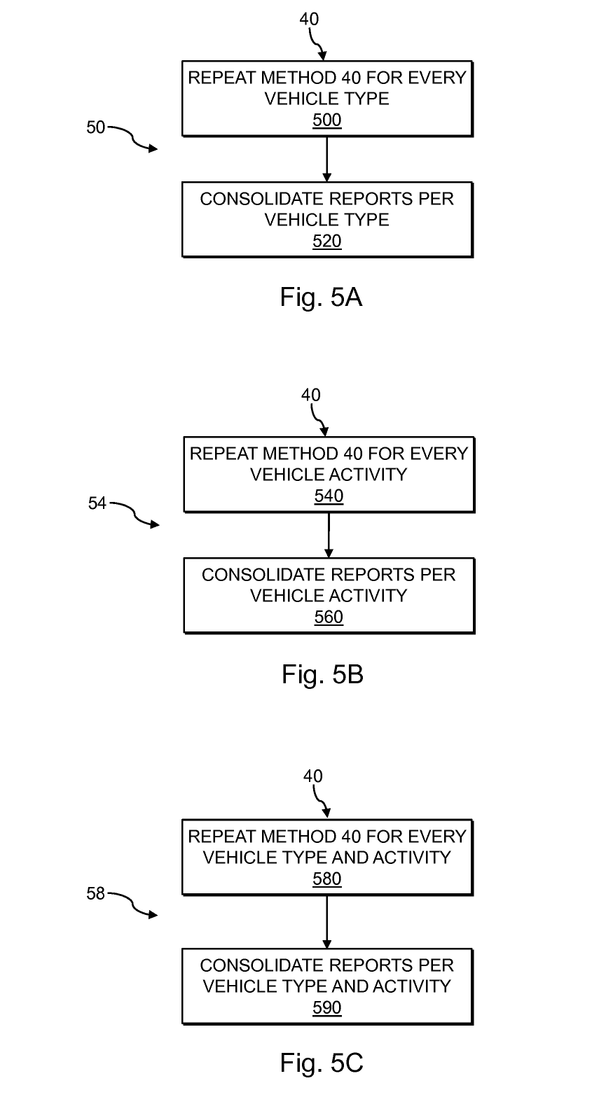

### Description—Alternative Embodiments—FIGS. 5-11

### 2. Reporting by Vehicle Type and Activity—FIGS. 5A-5C

A second embodiment of the multi-area emission reporting system 20 in accordance with the present invention is illustrated in FIGS. 5A-5C. Generally, the second embodiment delivers emission reporting for multiple vehicle types and activities. Furthermore, it creates a consolidated emission report.

### 2.1 First Variant—Reporting by Vehicle Type—FIG. 5A

The first variant of second embodiment is shown in FIG. 5A. As illustrated herein, the method 50 comprises repeating method 40 for every vehicle type 500 (macro step), and consolidating reports per vehicle type 520.

In macro step 500, the second embodiment advantageously utilizes the same system and methods that are utilized in the first, general embodiment (shown in FIGS. 2-4). Only an additional criterion of vehicle type 102 is enabled, and values of the criterion are defined in system 20. Type 102 is then typically included in fuel reports 268. Method 40 is preferably executed in parallel for each vehicle type 102 covered, at substantially the same time. It may also be repeated sequentially.

In step 520, a consolidated report for selected area(s) 125 is created, by control logic 224. The report includes attributed fuel consumption (AFC) 185 per each vehicle type 102. Furthermore, it may include ID 101 for each vehicle covered by AFC 185, or similar details. Alternatively, attributed emissions 195 may be reported, instead of AFC 185, per each type 102. The combined report may be distributed by communication unit 210 to relevant parties, in a similar manner as in the general embodiment (in step 480).

### Exemplary Embodiment for Two Vehicle Types

I illustrate further details on an example embodiment for shipping. Vehicles 100 are defined as sea going ships of a given type 102, of size 4,000 GT or over. The given type 102 is either a container ship or an oil tanker. For illustration, the total number of vehicles in such embodiment is approximately six thousand, comprising of circa four thousand container ships and circa two thousand oil tankers. The chosen size threshold excludes only a very small number of ships, typically serving Small Island Developing States and coastal shipping. The impact on number of ships and total emissions covered when compared with an alternative threshold of 400 GT are estimated by the Applicant at circa 5% and only less than 1%, respectively. The estimates are based on an analysis of data for relevant ships operating in 2009, including their number, total transport capacity, and total installed engine power.

Each submission of fuel report 268 by fleet admin 250 is for a given vehicle type 102. For this information to be recorded, type 102 may be included in the header of report 268, for all vehicles on the report.

In the case when fleet admin 250 is actually responsible for both containers and oil-tankers, it typically needs to submit two fuel consumption reports, one per each type of vehicle. These reports may be submitted at substantially the same time. The type of vehicle in each report is typically provided within the header of fuel report 268, rather than individually for each vehicle in the report.

In shipping, preferably the ship itself is the fuel entity. This reflects the typical regulatory regime in shipping where it is the ship that is subject to maritime regulations.

There are other advantages of reporting on a single vehicle basis. Each fleet 150 would be a single vehicle, vehicle 100. Vehicle ID 101 could be used as FID 151. Vehicle type 102 does not need to be provided in submissions at all, as it can be easily derived. For instance, the type could be looked up by registry 200 from the ship details that contain the type, by using ID 101. Furthermore, the risk for under- or over-reporting would be reduced.

Recording fuel consumption is a norm in shipping, so it could be easily reported. Furthermore, fuel receipts are obligatory. They are carried on board by every ship, and their key details are often stored electronically on-shore. In the preferred embodiment therefore, it is the amount of fuel purchased, as recorded on the fuel receipt, which is used to report fuel consumption. This simplifies reporting and allows additional validation with fuel suppliers. Alternatively, instead of fuel receipts, the ship's Oil Record Book can be used as the data source for fuel consumption.

Examples of UTA rule 170 introduced in Tables 1-2 are generic. A significant advantage of the first variant of the second embodiment is that UTA rule 170 may vary by vehicle type 102. Given that vehicles of different types typically travel at different speeds their energy efficiency may vary significantly. Therefore, the type-by-type approach will generally deliver a more accurate attribution of emissions to selected area 125.

For the shipping example UTA rule 170 is preferably related to the type of goods being carried by different ships. Specifically, container ships are volume-constrained by the number of containers they can carry, rather than their weight. Therefore for container ships the number of twenty foot equivalent containers (TEU) is preferred. For oil-tankers it is the weight, which is recorded in statistical freight records. Sample UTA rules 170 for the two types of ships are defined accordingly and are shown in Table 5.

TABLE 5
Sample UTA rules for oil tankers and container ships

| Vehicle Type | UTA rule |
|---|---|
| Oil Tankers | Share of oil imported to an area |
| Containers | Share of unloaded containers in an area, by TEUs |

In this shipping embodiment, the areas are defined as countries. A selected area can be any country. Once country is selected the value of the UTA rule can be determined or calculated from different sources of data. As an example, the world's share of oil imported to a country by oil tankers, can be obtained from the International Oil Pollution Compensation Fund, to which countries report the relevant data. The share of unloaded containers in a country can be obtained from the United Nations Conference on Trade and Development, which compiles relevant data (full containers). Alternatively, annual or more frequent data can be purchased from commercial sources that track both shipping sectors.

### 2.2 Second Variant—Reporting by Vehicle Activity—FIG. 5B

The second variant of the second embodiment expands method 40 to more than one activity 103 of vehicles 100, as shown in FIG. 5B. As illustrated herein, the method 54 comprises repeating method 40 for every vehicle activity 540 (macro step), and consolidating reports per vehicle activity 560.

Similarly to the first variant, macro step 540 advantageously utilizes the same system and methods that are utilized in the first, general embodiment (shown in FIGS. 2-4). Only an additional criterion of vehicle activity 103 is enabled, and values of the criterion are defined at the establishment of system 20. Activity 103 is then typically included in fuel reports 268. Method 40 is preferably executed in parallel for each vehicle activity 103 covered, at substantially the same time. It may also be repeated sequentially.

In step 560, a consolidated report for selected area(s) 125 is created, by control logic 224. The report includes AFC 185 for selected area(s) 125, per each activity 103 of vehicles 100. Furthermore, it may include ID 101 of each vehicle 100 covered by AFC 185, or similar details. Instead of, or in addition to AFC 185, attributed emissions 195 may be reported. The combined report may be distributed by communication unit 210 to relevant parties, in a similar manner as in the general embodiment (in step 480).

The advantage of this second variant is achieving a greater granularity and accuracy in emission reporting. Another advantage is the possibility of initiating reporting with a vehicle activity generating the majority of emissions, and phasing-in reporting for other activities some time later. For instance in aviation, these may be scheduled and non-scheduled flights. Yet another advantage is the possibility of applying activity-dependent UTA rule 170, in a manner similar to the one described in the first variant for vehicle type.

As an example, the second variant of the second embodiment may apply in aviation. Activity 103 can be defined as: scheduled flights, and non-scheduled flights. It may also be defined as: long-haul, and short-haul flights, or as passenger flights, and cargo flights. Although theoretically possible to define activity 103 as international flights and domestic flights, this is not preferred. Instead the third embodiment described in the next section covers more complex international aviation.

### 2.3 Third Variant—Reporting by Vehicle Type and Activity—FIG. 5C

The third variant of the second embodiment expands method 40 to both types and activities of vehicles 100. This variant combines the variants one and two into one embodiment.

The third variant is shown in FIG. 5C. As illustrated herein, the method 58 comprises repeating method 40 for every vehicle type and activity 580, and consolidating reports per vehicle type and activity 590.The execution of macro step 580, and report consolidation step 590 by control logic 224 are very similar to descriptions of relevant steps for the first and second variants, above. The third variant combines functionality and advantages of both the first and second variants.

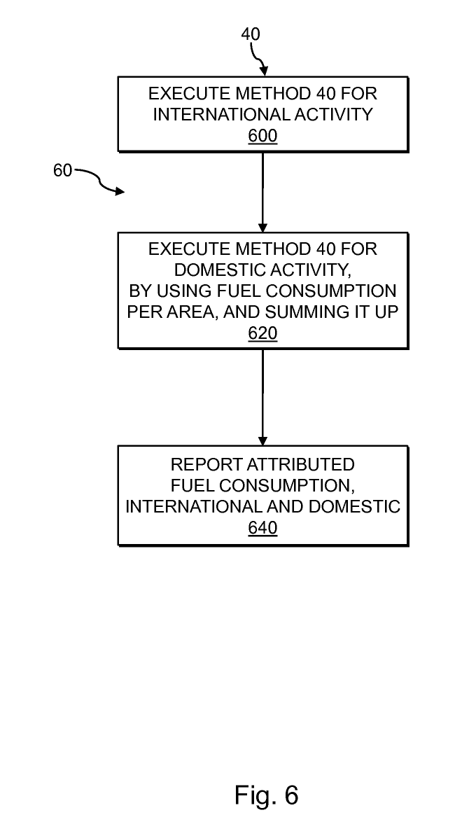

### 3. Reporting Consolidated Domestic Emissions—FIG. 6

A third embodiment of the multi-area emission reporting system 20 in accordance with the present invention is illustrated in FIG. 6. Generally, the third embodiment combines attribution of international emissions with the aggregation of domestic emissions within a single system using a method 60.

The third embodiment advantageously utilizes the same system and methods that are utilized in the first, general embodiment (shown in FIGS. 2-4). Specifically, the areas 110 and 120 in this embodiment are typically defined as countries. Activity 103 is used as a criterion to distinguish two different modes of reporting of fuel consumption in system 20. The modes are international and domestic, for activities defined as international and domestic, respectively.

International and domestic activities may be defined as in the 2006 IPCC Guidelines for National Greenhouse Gas Inventories, Volume 2: Energy, Chapter 3: Mobile Combustion; available at http://www.ipcc-nggip.iges.orjp/public/2006gl/pdf/2_Volume2/V2_{—}3_Ch3_Mobile_Combustion.pdf. A journey or voyage is domestic when it departs and arrives in the same country. It is international when it departs in one country and arrives in another. In aviation, this applies to individual legs of journeys with more than one take-off and landing. In shipping, this applies to each segment of a voyage calling at more than two ports.

For international activity the process follows method 40 with system 20, as previously described.

For domestic activity system 20 applies different logic, as there is no need to attribute fuel consumption to selected area 125. Associated domestic emissions belong to a relevant domestic area, already. Therefore, for domestic activity, each fleet admin 250 reports domestic fuel consumption to registry 200. Subsequently, registry 200 aggregates the domestic fuel consumption reported.

As shown in FIG. 6, method 60 comprises executing method 40 for international activity 600 (macro step), executing method 40 for domestic activity 620 (macro step), and reporting attributed fuel consumption 640, for both international and domestic activities.

In macro step 600, method 40 is executed for international activity of vehicles 100, using system 20. Each fleet admin 250 submits fuel report 268 for international activities only, performed by its vehicles 100. Registry 200 performs its functions, as in the general embodiment. The result of the method 40 is AFC 185 from international activities for all of

In macro step 620, method 40 is executed again but for domestic activity of vehicles 100, using system 20. Therefore, fleet admin 250 submits report 268 for domestic activities only, performed by fleet 150 of vehicles 100. Apart from typical fuel data per vehicle, report 268 includes also domestic fuel consumption area-by-area, preferably for all vehicles covered by the report, rather than individually per each vehicle. For this, fleet admin 250 uses provisions for additional data in fuel report 268, such as previously illustrated on FIG. 3A as additional data 310.

Fuel report 268 is marked as domestic, for instance by including activity 103 in the header of the report. When such domestic fuel report 268 is received by registry 200, FC 108 for each vehicle is stored in data storage as domestic, by storing activity 103 in corresponding vehicle record. Additionally, fuel consumption per area, provided in additional data of fuel report 268, is stored directly in corresponding area accounts within data storage 226.

During calculation of AFC 185, UTA rule 170 is not applied to domestic fuel consumption. The needed outcome has been already reported in “attributed” form, through additional data. Every record containing FC 108, and marked as domestic through activity 103 is not used in the attribution process at all. Instead, to obtain AFC 185 for domestic activities for selected area 125, registry 200 sums up domestic fuel consumption stored in the corresponding area account, for all fleets.

Even though still called attributed, AFC 185 in this domestic macro step is in fact a consolidated value. The consolidated value is for domestic fuel consumption per selected area 125 as provided by all of fleet admin 250. This can be reported, as per method 40, with editorial name changes on the report.

In one embodiment, the logic of not using the domestically marked FC 108 in the attribution process is replaced with a nil domestic UTA 170 rule. Multiplying by nil (zero) eliminates the domestically marked FC 108 from the attribution process. The consolidation, summing up of stored domestic fuel consumption for the given area, is performed as above.

In step 640, values of AFC 185 for both international and domestic activities are reported. Alternatively, attributed emissions 195 for both international and domestic activities may be reported. Furthermore, identities of vehicles 100 covered by the report may be included.

The method 60 in FIG. 6 is shown as including the two macro steps 600 and 620 in order to reuse previously described systems and methods. In reality, fleet admin 250 can submit reports with international fuel consumption and domestic fuel consumption in parallel, at substantially the same time.

Furthermore, a single consolidated report may be submitted, by using activity 103 to identify international and domestic records in fuel report 268. Subsequently, only fuel consumption stored in vehicle accounts of registry 200 as international is subject to attribution per area. Domestic fuel consumption stored in area accounts of registry 200 is subject to consolidation, area by area. This functionality is built-in into registry 200, as it can record and process data per activity 103.

By way of example, method 60 is well suited for embodiments for emissions from aviation. In one embodiment, each aircraft operator, functioning as fleet admin 250, submits a consolidated report containing fuel consumption for its aircraft, for domestic and international flights. Given that fuel is uplifted to aircraft typically before each flight, the aircraft operator generally has accurate data on fuel consumption for international and domestic flights.

Illustrative elements of the domestic report for such embodiment are shown in Tables 6A and 6B, for vehicle-part and area-part, respectively. The vehicle-part provides domestic fuel consumption per each vehicle. The area-part provides domestic fuel consumption per each selected area, for all vehicles together covered by the report. Illustration of the international report, not shown, is very similar to Table 6A alone, as it does not include the area-part shown in Table 6B.

TABLE 6A
Vehicle-part of sample domestic fuel record

| | | | | Fuel | |
|---|---|---|---|---|---|
| | | | | Consumption | |
| | | Period | | Jet Fuel | AvGas |
| Aicraft ID | Activity | From | To | (t) | (t) |
| A1B2C3D | Domestic | 01 Jan. 2010 | 31 Dec. 2010 | 12,564 | — |
| B3C4D5E | Domestic | . . . | . . . | . . . | . . . |
| . . . | Domestic | . . . | . . . | . . . | . . . |

TABLE 6B
Area-part of sample domestic fuel record

| | | | | Fuel | |
|---|---|---|---|---|---|
| | | | | Consumption | |
| | | Period | | Jet Fuel | AvGas |
| Area | Activity | From | To | (t) | (t) |
| USA | Domestic | 01 Jan. 2010 | 31 Dec. 2010 | 240,875 | 40,100 |
| . . . | Domestic | . . . | . . . | . . . | . . . |

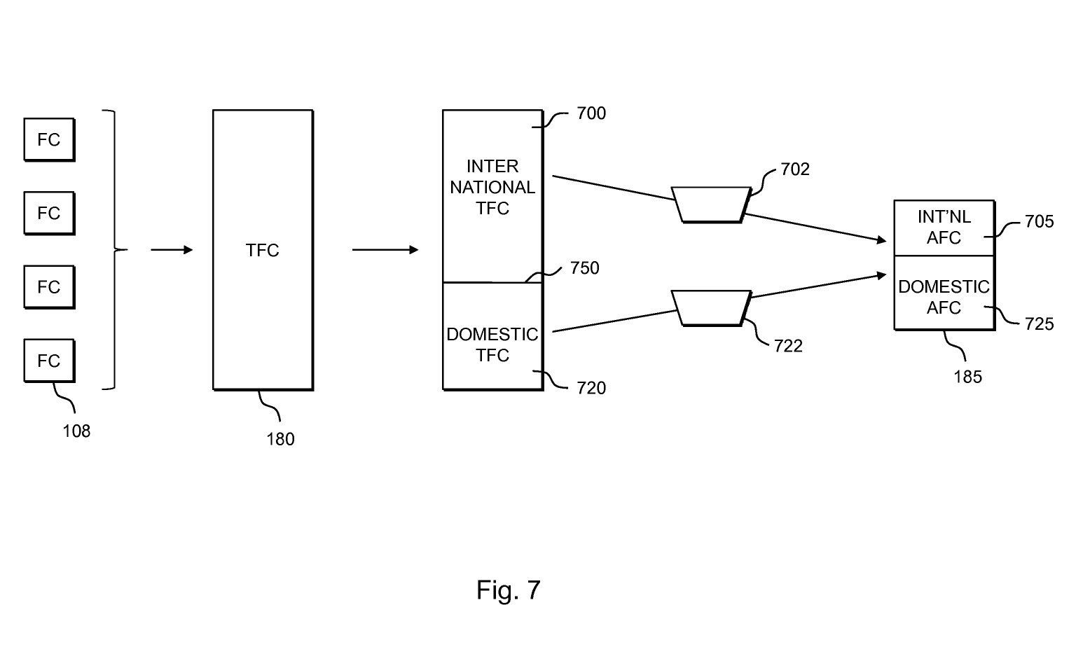

### 4. Reporting Attributed International and Domestic Emissions—FIG. 7

A fourth embodiment of system 20 in accordance with the present invention is related to attributing international and domestic emissions to a given area, and their reporting, when domestic emissions cannot be easily quantified.

In the third embodiment just described, reporting of domestic fuel consumption per area is or may be required. In aviation, such data is typically available only to aircraft operators but not to fuel suppliers, and similar entities. The fuel supplier that delivered fuel to the aircraft does not know whether the next flight is international or domestic. In shipping, this is even worse, as the fuel purchased may last a month and be used for both domestic and international activities. In general, data for domestic fuel consumption may be imprecise or difficult to obtain.

FIG. 7 illustrates the novel approach used in the fourth embodiment to calculate and report both the international and domestic parts of AFC 185. It relates to establishing UTA rule 170 to reflect both parts.

In the first, general embodiment FC 108 from all vehicles are obtained, and aggregated into TFC 180, as schematically illustrated. No information is provided on the domestic fuel consumption by fleet admin 250. Therefore, for reasons described, TFC 180 cannot be further divided into parts, international and domestic.

In this embodiment TFC 180 is split by a yet undefined rule into two parts, an international TFC 700 and domestic TFC 720, as shown in FIG. 7.

An international UTA rule 702 is then be applied to 700 to produce an international AFC 705. Similarly, a domestic UTA rule 722 is applied to 720 to produce a domestic AFC 725. The international and domestic portions of AFC 185, attributed to selected area 125, are therefore calculated as 705 and 725, respectively.

The key to this process is establishing how to split TFC 180 into its constituent parts 700 and 720. To establish the split, I use a total domestic share of total activities (TD share of TA), shown as 750. TD share of TA 750 is preferably calculated from statistics for total domestic activities and total activities for vehicles in system 20. For aviation, international and domestic activities are typically defined as international and domestic flights, respectively. As an example, TD share of TA for aviation globally was approximately 40%, in 2007 (based on ICAO data).

Once TD share of TA 750 is calculated it establishes parts 700 and 720. Subsequently, both parts of AFC 185 can be calculated, from the following formulas (numerals omitted in the second formula):

domestic AFC 725=TFC 180×TD share of TA 750×domestic UTA 722;

international AFC=TFC×(1−TD share of TA)×international UTA.

The fourth embodiment advantageously utilizes the same system and methods that are utilized in the first, general embodiment (shown in FIGS. 2-4). Specifically, electronic registry 200 uses two UTA rules, an international UTA rule and a domestic UTA rule. The international UTA rule is typically established in the same way as UTA rule 170. Given that domestic end users are mostly responsible for domestic emissions, the domestic UTA rule is preferably established through statistical data directly related to vehicle domestic activities or domestic fuel consumption.

In system 20, electronic registry 200 obtains and uses TD share of TA 750. Both international UTA rule 702 and domestic UTA rule 722 are defined in direct relation to TD share of TA 750. In the preferred embodiment international AFC 705 and domestic AFC 725 are calculated as per the formulas above, for any selected area 125.

The following provides details of an exemplary embodiment for aviation. Areas are defined as countries. Vehicles 100 are aircraft of maximum take-off weight (MTOW) greater than 5,700 kg. Fuel entities are aircraft operators. Vehicle activity is any activity not defined as excluded activities. As an example, excluded activities are flights related to search and rescue, firefighting flights, humanitarian flights and emergency medical service flights. International activity is defined by international flights; domestic activity is defined by domestic flights.

In an alternative exemplary embodiment, fuel entities are fuel suppliers of aviation fuel. The example MTOW size threshold of 5,700 kg coincides with the threshold used in airworthiness legislation. Other MTOW threshold could be used, such as 8,618 kg, or 34,000 kg. Thresholds based on the maximum certified passenger capacity of the aircraft could also be used, or used together with the MTOW.

As a measure of aviation activities I use the standard ton-kilometers flown. In the preferred embodiment, available ton-kilometers (ATK) are used, as activities expressed in ATK do not depend on the business model selected. For instance, they do not depend on aircraft seating arrangements and number of passengers flown. Alternatively, revenue ton-kilometers (RTK) are used. The relevant data for aviation activities, in ATK and RTK, can be obtained from industry sources, such as ICAO and Airports Council International.

Domestic UTA rule 722 is defined as a country or area share of total domestic activities. To calculate it, data on country and total domestic activities is obtained from industry sources, preferably in ATK. This data is obtained for each selected country, or area. International UTA rule 702 may be defined through one of the rules listed earlier in Table 1. By way of example, it may be defined as a country share of global imports.

With these definitions in place, central registry 200 can calculate and report attributed international and domestic fuel consumption (705 and 725), and derived attributed emissions for them, for any selected country, or area. Each aircraft operator needs only to report fuel consumption of its fleet of aircraft to central registry 200, through its fleet admin 250. It does not need to provide any other details, such as domestic fuel consumption per each country. All the attribution is done top-down by central registry 200, by using obtained values of TD share of TA 750, international UTA rule 702, and domestic UTA rule 722, as illustrated in FIG. 7, and provided by relevant equations above.

The above embodiment could also apply to global shipping and fuel suppliers as fuel entities. It also could apply to global shipping with ships themselves being the fuel entities. However, as the share of domestic activities for global shipping is typically low this may not be required. Being small, the domestic part may not require separate reporting for shipping.

In the fourth embodiment, advantageously very limited data on fuel consumption is required, while attributed fuel consumption is calculated for both international and domestic activities. This is achieved in a way not described in previous art, to the best knowledge of the Applicant.

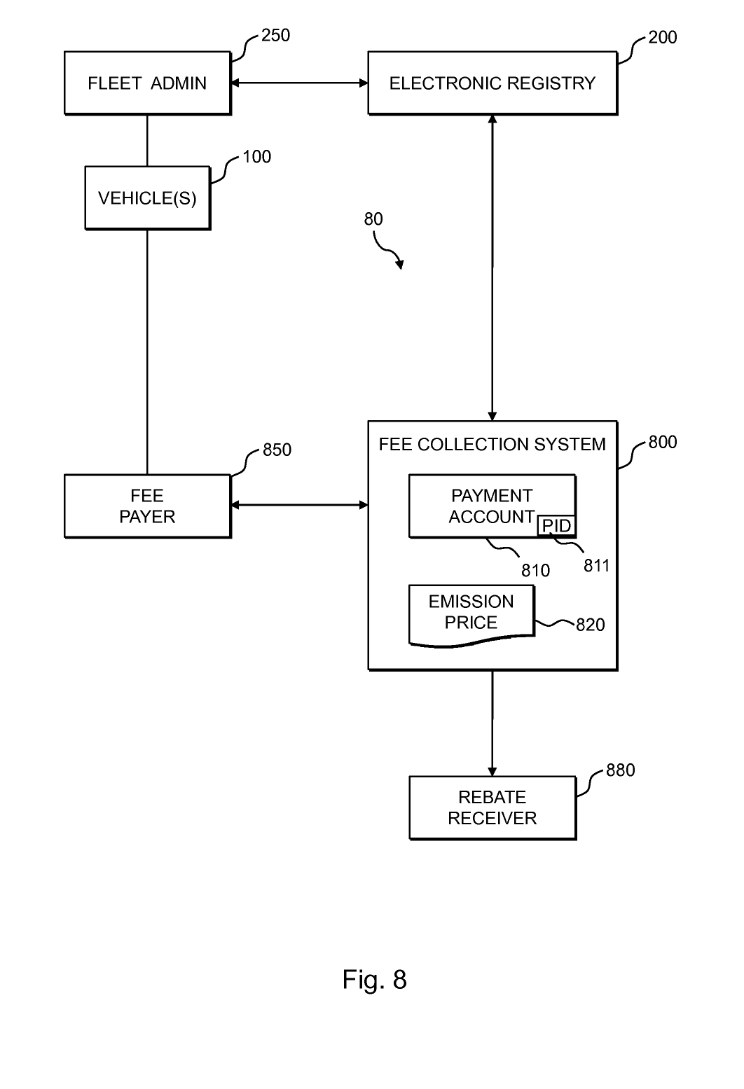

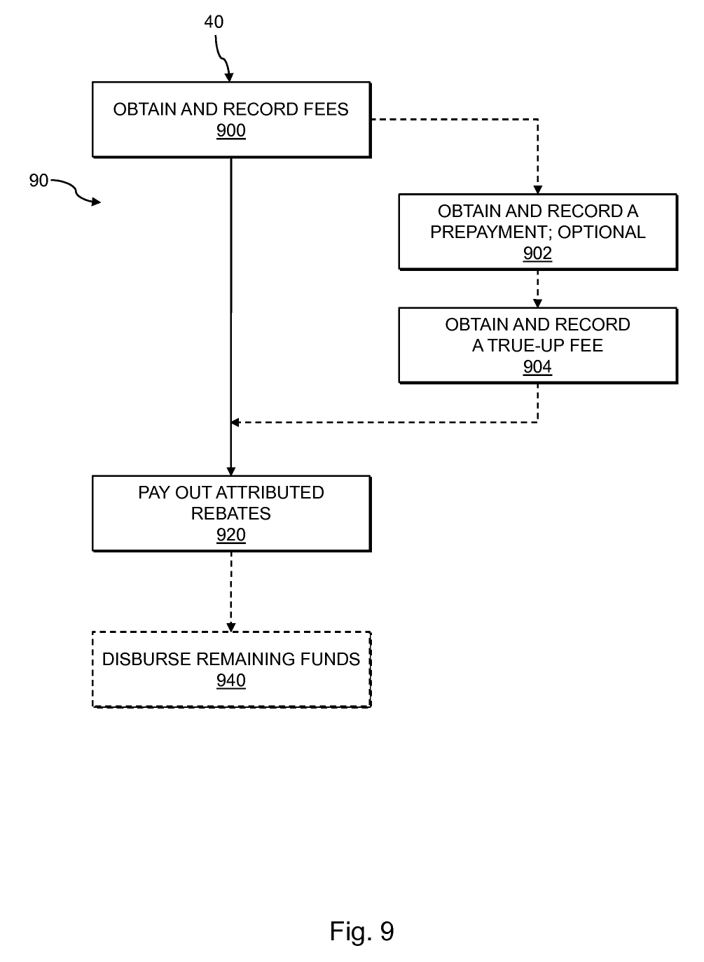

### 5. Multi-Area Emission Reduction Scheme—FIGS. 8-9

A fifth embodiment of system 20 in accordance with the present invention is related to establishing a multi-area emission reduction scheme. The reduction scheme is achieved by adding an emission fee collection system and a method to the first, general embodiment.

FIG. 8 illustrates a block diagram of the multi-area emission reduction system for vehicles 80. Building on system 20, system 80 nominally includes electronic registry 200, at least one fleet admin 250 for vehicle(s) 100. Furthermore it nominally includes a fee collection system 800, a fee payer 850, and a rebate receiver 880. Typically there are many fee payers 850, and more than one rebate receiver 880.

### Fee Collection System 800

Fee collection system 800 has at least one payment account 810, with a unique identifier PID 811. An emission price 820, which applies to emissions from vehicles 100, is shown as part of system 800.

Fee payer 850 is an entity that pays for emissions from one or more of vehicles 100 to payment account 810. Typically it is the same entity that pays for vehicle fuel, for instance the aircraft operator.

Rebate receiver 880 is an entity that may receive a rebate or a refund for the overall participation in the scheme. Typically it is a government or another area-related entity, rather than fee payer 850. The term “rebate” has therefore a more general meaning in this context. For instance, rebate receiver 880 may be a government of a developing country, thereby reflecting differentiated responsibilities and capabilities of developed and developing countries.

A significant feature of this embodiment is that it provides a system and method of obtaining emission fees for vehicles 100, and potentially providing rebates. As in the general embodiment each fleet admin 250 submits a limited number of fuel reports to electronic registry 200. From these data, electronic registry 200 creates reports for AFC 185 or attributed emissions 195, per each selected area.

Fee collection system 800 collects an emission fee for vehicles 100 from fee payers 850. It stores payment information in payment accounts 810, and the emission fees in a treasury (not shown). At the end of a predetermined period, fee collection system 800 may provide rebates to rebate receivers 880. System 800 calculates the rebates typically from predetermined rebate ratios and the amount of emission fees collected from fee payers 850.

Fee collection system 800 may be separate from electronic registry 200, as FIG. 8 suggests. It may comprise a central system with several sub-systems (not shown). In another embodiment, system 800 is integrated with registry 200 into one reporting and fee collection system.

Payment account 810 is typically run in emission units rather than in monetary terms. For instance, in tons of carbon dioxide, or tons of carbon dioxide equivalent. Any payment received by system 800 is therefore typically expressed or translated into emission units. The translation uses emission price 820 prevailing at the time of payment made by fee payer 850. Payment account 810 typically holds the balance of emission units paid, but may also hold full transaction details.

Status of payment account 810 may be provided by fee collection system 800 to third parties for information, enforcement actions, and similar (not shown).

By way of specific example, fee collection system 800 may be a commercial banking system. In another embodiment it may be the Oracle Financials application running on a workstation, such as Hewlett Packard model HP Z600.

### Operation of System 80

The operation of system 80 will be described in detail with reference to FIG. 9. As embodied in FIG. 9, method 90 incorporates method 40, followed by obtaining and recording fees 900, paying out attributed rebates 920, and optionally disbursing remaining funds 940. Step 900 may further comprise the steps of, optionally, obtaining and recording a prepayment 902, and obtaining and recording a true-up fee 904.

### Obtaining and Recording Fees 900

In step 900, fees or payments for emissions are obtained and recorded. The fee is preferably monetary and directly related to emission price 820. The fee is obtained from fee payer 850 by system 800. The process may include multiple payments, for instance quarterly payments.

In the preferred embodiment, emission fees are obtained vehicle by vehicle. Each vehicle 100 has a payment account 810 established in fee collection system 800. Typically PID 811 equals vehicle ID 101, as used in electronic registry 200. The emission fee is calculated from emissions of vehicle 100 and emission price 820. The emissions of vehicle 100 are derived from vehicle fuel consumption (FC 108) obtained from electronic registry 200, and relevant emission factors.

In another embodiment, the emission fees are obtained fleet-by-fleet. Each fleet 150 has a payment account 810. In this case, PID 811 typically equals fleet FID 151. The emission fee is calculated from emissions of fleet 150 and emission price 820.

In yet another embodiment, the emission fees are obtained area-by-area. Each selected area 125 has a payment account 810, with a unique identifier. The emission fee is calculated from attributed emissions 195 and emission price 820. In this embodiment, fee payer 850 may be a government of the area, or similar.

Furthermore, an electronic receipt may be issued by system 800 to fee payer 850 after each payment is received. Periodically, an electronic or physical certificate of payment of the emission fees may be issued to each fleet 150, or to each vehicle 100.

### Paying Out Attributed Rebates 920

In step 920, attributed rebates are paid out to predetermined rebate receivers 880. They are paid out by system 800 from the funds created by aggregating emission fees obtained in step 900.

In the preferred embodiment each rebate receiver 880 is associated with one selected area 125. The rebates are paid out in proportion to a rebate ratio. The rebate ratio may be defined as the share of emissions attributed to selected area 125, and may be calculated by dividing attributed emissions 195 by total emissions 190. Typically, only some of the selected areas are eligible for the rebates.

In the preferred embodiment, the rebate ratio is obtained by further multiplying the above share of emissions attributed to the selected area by a rebate rate. The rebate rate is a predetermined number for each selected area, typically ranging from 0 to 1. Therefore, areas with rebate rate of 0 do not receive any rebates. Areas with rebate rate of 1 get a full rebate of their economic costs associated with the scheme, as per their share of attributed emissions. Other selected areas get a partial rebate.

In one embodiment the rebate rate of 0 is for developed countries, and 1 for developing countries. In another embodiment, a rebate rate look-up table is created with a value for each country or area. The country values may be established through so called responsibility-capability factors, for instance calculated using the Greenhouse Development Rights framework. They may also be established through a negotiated agreement or commitments, not necessarily through a formula, and their values may be greater than 1.

### Disbursing Remaining Funds 940

In step 940, remaining funds are disbursed. Funds remaining after paying out attributed rebates are disbursed to one or more of predetermined organizations or programs. They may be disbursed according to a predetermined key specifying how the funds are disbursed between them. The key may change with time.

In the preferred embodiment, the remaining funds are disbursed to action on climate change, typically after accounting for administration costs of the scheme. The relevant organization may include the Adaptation Fund and Forestry Fund, established under the UNFCCC. Furthermore, they may include a Maritime Technology Fund and an Aviation Technology Fund, for shipping and aviation embodiments, respectively. These technology funds may for instance support R&D of clean technologies, vessels and engines. They may also provide refunds for quantity of vehicle emissions captured or scrubbed, and provide other incentives for reducing emissions. Other external funds may also be beneficiaries of the scheme. Management of these external funds is outside of the scope embodiments and therefore is not discussed in this application.

With continuing reference to FIG. 9, step 900 may further comprise obtaining and recording prepayments 902, and obtaining and recording a true-up fee 904. The true-up fee is a fee for yet unpaid emissions. It is like an outstanding or a top-up fee.

### Obtaining and Recording a Prepayment 902

In step 902, a prepayment for the emission fee may be obtained and recorded in payment account 810. As described, it is typically recorded in emission units. The balance of prepayments defines therefore prepaid emissions.

It is an optional step, and the prepayment may be voluntary, compulsory or a combination of both. For instance, in one embodiment, the prepayment is implemented as a compulsory fee paid when purchasing fuel in a predetermined area. In another embodiment, this compulsory fee is paid in all areas. In both cases, fuel suppliers may collect the fee at the point of sale, and then pay it to account 810. In another approach, they may collect the fee, provide relevant details to account 810, but pass the collected fee to a predetermined collection authority, such as a national treasury. In yet another embodiment, the prepayment is voluntary and may be made at any time by direct payments to account 810. Any number or prepayments may be obtained and recorded. These may be facilitated through the use of smartcards, direct payments, and similar payment processes and techniques.

### Obtaining and Recording a True-Up Emission Fee 904

In step 904 a true-up fee is obtained and recorded. The true-up fee is due for any unpaid emissions, calculated typically at the end of an accounting or obligation period. The true-up emission fee is typically compulsory. It can be seen as a top-up to the emission prepayments. The true-up fee is typically determined by multiplying unpaid emissions by an average of emission price 820 for the accounting period.

In a special case when prepayments are compulsory everywhere, for instance collected through fuel suppliers, this step may not be required.

Unpaid emissions are generally calculated as the difference between the vehicle emissions and prepaid emissions. When unpaid emissions are positive a true-up emission fee is due. When they are negative, no true-up fee is due.

The true-up emission fee may be obtained and recorded in several ways. These include: direct payment to the payment account 810, billing and collection with predetermined settlement time, and similar payment practices. The billing and collection typically involve predetermined settlement time, and may allow for consolidation across several payment accounts for larger fee payers. More than one way to obtain the true-up fee may be supported in any embodiment.

Any overpayment is typically carried-over as a prepayment for the following accounting period. If the true-up emission fee is underpaid or not paid within a predetermined time period, a vehicle associated with payment account 810 can be declared non-compliant and subject to an enforcement regime. Typically enforcement is through declining to issue annual certificate for vehicle 100. Additionally, non-compliant vehicle 100 may be declined entry to port or be arrested, until the emission fee due and any penalties are settled. In case more than one vehicle is associated with payment account 810, any of the vehicles may be subject to an enforcement regime. This is similar to recovering an unpaid fuel bill from a ship by arresting another ship belonging to the same company, until the unpaid fuel bill is settled.

Integration with Emission Markets and Policies

Embodiments of the present invention may operate on enterprise, national, regional, and global levels. These embodiments may be integrated with emission policies and markets in generally two integration approaches. These approaches are especially pertinent to the fifth embodiment due to the need to specify emission price 820.

The first integration approach is based on national accounting for emissions from vehicles 100. Each country or area may incorporate AFC 185 or attributed emissions 195 in its national totals or emission accounts.

The second integration approach is based on group or sectoral accounting for emissions from vehicles 100. Here, these emissions are outside of national emission totals. In this approach, vehicles 100 typically have a group emission reduction goal (G). Any country or area may still incorporate AFC 185 or attributed emissions 195 in its national totals or emission accounts.

### Establishing an Emission Price

The integration approach influences how emission price 820 may be defined. In each case however, emission price 820 is preferably linked to the market emission price (MEP).

MEP typically equals price of emission allowances, emission reduction certificates or similar credits. For GHG embodiments, this may be referred to as a carbon price. MEP may be historical, current, or forward market price. MEP may be global, if such already exists. It may be equal to the price established by the USA or another economy-wide emission reduction scheme or program, or to the price established by the largest such scheme.

MEP may also be a weighted average of emission prices for several emission schemes or markets. Preferably, a rolling average price is used, instead of a spot price. The rolling average is over a predetermined period of time, such as a week, month, quarter, and so on. Additionally, MEP, or its derivative used for the price linkage, can be constrained to a predictable range through an emission price floor and a ceiling. As an example, the price floor and ceiling may be defined as $10 and $20 per ton of CO2 during calendar year 2013, respectively. In subsequent years the price floor and ceiling may be defined through their annual increases, for instance 3% and 5%, respectively (excluding rate of inflation).

In the national accounting approach, emission price 820 is preferably directly linked to MEP. If MEP is established through a tax on emissions, or a similar scheme, price 820 may be simply set at the MEP level. If MEP is established or driven by an emission trading scheme, adjustments for free emission allowances prevailing in such scheme may be needed. If other sectors do not receive any free emission allowances, there is typically no need for any adjustment. Otherwise, an adjustment is typically implemented, for instance as follows. If MEP is established in a scheme with 20% of free allowances, emission price 820 may be initially set at 80% of MEP (100%-20%). As a result, vehicles 100 would be subject to similar emission price as the other sectors, delivering proportionality of effort. More sophisticated adjustments can be made, for instance by further considering different rates of emission growth from the other sectors and from vehicles 100.

The simplicity of the above linkage of emission price 820 to MEP arises from the environmental integrity of national accounting approach. The attributed emissions indirectly influence MEP. For instance, if they grew rather than declined, then the other sectors would have to reduce their emissions more to stay within the overall national emission budget or target. This would automatically increase the MEP price.

In the sectoral accounting approach, typically a group emission reduction goal (G) is established for vehicles 100. Emission price 820 is preferably linked to MEP through a multiplier or rate R, where R is a function of G. The formula is: emission price 820=R×MEP. For a practical example, consider that MEP equals the price of emission offsets or credits. If the above price 820 is levied on total emissions from vehicles 820, the amount of revenue raised is: total emissions×R×MEP. Therefore this revenue would allow to offset, at MEP price, a share of total emissions equal R. Therefore, rate R can also be seen as a percentage of MEP that should be charged on emissions to offset emissions over G. To clarify further, different goals are analyzed below.

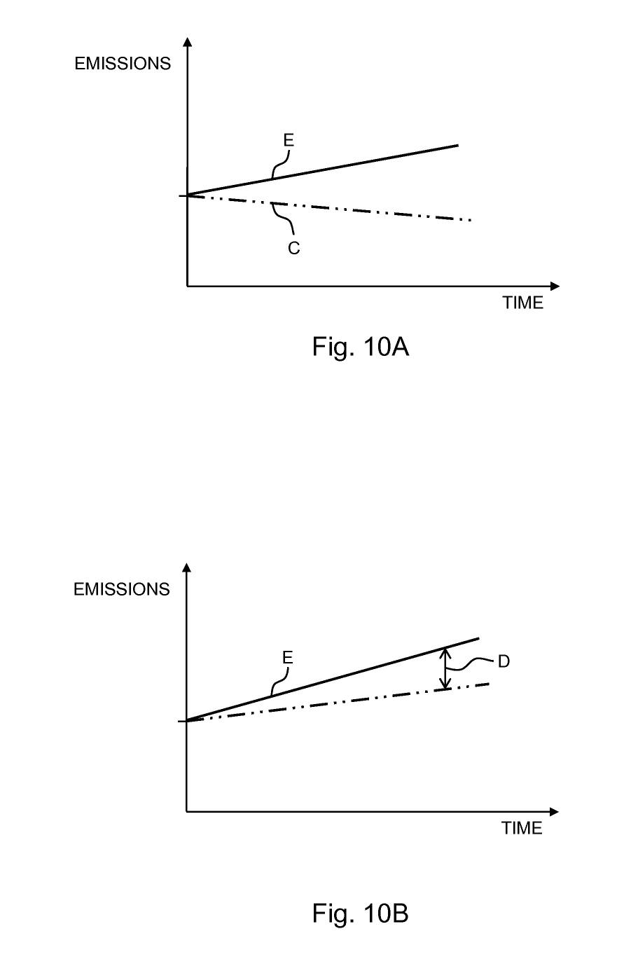

### Establishing Emission Price in Relation to Emission Reduction Goal—FIGS. 10A-10B

Goal G may be established as an emission cap (C) or as an emission deviation (D), as illustrated in FIG. 10A and FIG. 10B, respectively. Preferably, cap C is established as relative emission reductions in relation to emissions in a given reference year, or years. For instance, reduce emissions by 20% below a 2005 level by 2020.

Preferably, deviation D is established as relative deviation below the business-as-usual (BAU) emissions. For instance, deviate below BAU emissions by at least 15% over 15 years. Alternatively, deviate by 1% annually.

Relative goals are preferred over goals defined in absolute terms. For instance, assume that goal G is defined in absolute terms as cap C of 100 MtCO2. If vehicle scope or participation changes, for instance doubles, such an absolute goal needs adjustment. However, if G is defined in relative terms it does not need adjustment, providing the emission profile of new participating vehicles is broadly the same as the existing ones.

Emission price 820 depends on how ambitious goal G is. As illustrated in FIGS. 10A-10B the ambition is determined by an emission “wedge” between by the projections for vehicle emissions (E) and the goal. The size of the wedge is quantified by rate R, and is calculated below for the two goal types.

For cap C, as illustrated in FIG. 10A, the wedge is between E and C. Rate R therefore depends on E and C, as follows. The difference between E and C is the quantity of emissions over cap C. This difference divided by E provides rate R, equal to relative size of the wedge. Rate R is typically calculated for the given year, or period. The formula is: R=(E−C)/E.

For deviation D, the emission wedge is shown in FIG. 10B. The wedge is determined by deviation D itself. Given that, in the preferred embodiment D is expressed in relative terms, rate R equals D. The formula is: R=D.

Thus, rate R can be easily derived for both the emission cap and deviation goal. The two sample formulas to calculate rate R are summarized in Table 7.

TABLE 7
Sample formulas to calculate rate R

| Goal definition | R |
|---|---|
| Cap | (E − C)/E |
| Deviation | D |

Cap C, deviation D, and emissions projections E can be calculated or approximated through a variety of ways, including annual schedules.

Deviation D is preferably defined through a linear rate, such as 1% annual deviation.

For cap C and projections E, typical formulas are linear and exponential. This is described on an example of cap C. In the linear approach C is defined as a straight line schedule defined by an annual growth rate (CR), starting from 0. The exponential approach uses a compound growth curve, wherein CR is defined as the compound annual growth rate of C. In this definition for C to decline, the value of CR needs to be negative.

Sample formulas for C for the linear and exponential schedules are shown in Table 8. The ̂ A function returns the result of a number raised to the power of N, wherein N is defined as a number of years from a reference year. In the formulas, C is normalized to 1 at the reference year, for which N=0.

TABLE 8
Sample formulas for a relative cap schedule

| Schedule | Cap (C) |
|---|---|
| Linear | 1 + N × CR |
| Exponential | (1 + CR)\hat{ }N |

Similar formulas apply to projections E (not shown). Both E and C are normalized to 1 at the reference base, for N=0.

The value of CR is typically calculated from a longer-term goal. For a sample goal to reduce emissions by a fifth (by 20%) over 15 years the CR values are calculated as follows. For the linear trajectory CR=−1.33% (equal to −20/15). For exponential trajectory CR=−1.48%. The negative sign signifies that cap C declines. This value was calculated so that (1−0.0148)̂15=0.8.

The projected growth rate of emissions ER is typically obtained from external sources. Rate ER is the net annual growth rate of E, after taking into account any efficiency improvements. Therefore, from rate ER projections E can be easily calculated. Typically, formulas similar to the ones used for C, shown in Table 8, are used.

Rate R can then be calculated. By way of practical example, linear trajectories are assumed for E and C. The formula for R from Table 7 becomes the following: R=N×(ER−CR)/(1+N×ER).

As an example, emissions from international aviation and international maritime transport are considered over the period from 2005 to 2020. Emission goals are defined through sector caps on emissions. C is assumed as −10% and −20%, for aviation and maritime respectively. Each C value is for emissions in 2020 compared to levels in 2005. Dividing each C by number of years, 15, provides values for CR for both sectors. ER annual growth rates are estimated as 3% and 2%, for aviation and maritime respectively. Rates R are calculated using the above formula. Sample results for 2013 and 2020 are illustrated in Table 9, obtained for N of 8 and 15, respectively.

TABLE 9
Rate R for different sectors and emission caps

| | | Growth Rates (linear) | | R | |
|---|---|---|---|---|---|
| Sector | Cap (2020) | ER | CR | 2013 | 2020 |
| Aviation | −10% | 3% | −0.67% | 23.7% | 37.9% |
| Maritime | −20% | 2% | −1.33% | 23.0% | 38.5% |

Calculation of R for deviation D is even simpler. As an example, emissions from international transport in developing countries could be agreed to deviate from BAU emissions by 15% over the period from 2005 to 2020, instead of being capped. This is equivalent to a 1% annual deviation, or improvement. As investments are needed to get there, a price on emissions could be established through rate R. In 2013, after 8 years from 2005, R is equal 8%, as per formula in Table 7. In 2020, R is equal 15%.

For both cap C and deviation D, the calculated rates R are in fact minimum rates. Emission fees collected at such rates could buy enough emission reduction credits, or similar, as required to achieve the emission reduction goals established.

Rate R may be adjusted upwards to account for additional costs or contributions. This may be used to align emission costs faced by others sectors, such as costs of acquiring a percentage of emission allowances through auctions. The adjustments may be to cover the costs of running the scheme, and so on. Furthermore, indirect environmental impacts of transport emissions may be incorporated on top of minimum rate R. A final rate (FR) may therefore be shown through a formula such as: FR=(1+impact adjustment factor)×(R+cost adjustment rate).

As an example, the cost adjustment rate could be set at approximately 8%, with the additional financing going to technology R&D, or similar. For embodiments for aviation, the impact adjustment factor could be set as approximately one. This would reflect the non-CO2 impacts of aircraft emissions on global warming.

### Advantages

Advantageously, the preferred relative approach described above eliminates issues of an uncertain emission baseline, as the baseline is not required. Baseline uncertainty, which is typical of transport, is a major barrier to implementing cap-and-trade for transport.

Furthermore, expressing emission projections E in relative terms has a significant accuracy advantage. The Applicant has made an important discovery in relation to emission projections for international transport. Projections for absolute emissions from international maritime transport vary significantly by nearly a factor of two. However, when these projections are normalized versus emissions in a given year, such as 2005, the derived relative emission projections vary very little. Similar benefits of using relative emission projections were confirmed for international aviation.

The incorporation of a deviation goal provides another advantage. Embodiments of the present invention can operate with deviation goals while cap-and-trade schemes only allow emission caps. Goals defined through emission deviation appeal to many countries that object to hard emissions caps on equity grounds, such as developing countries.

### CONCLUSION, RAMIFICATIONS, AND SCOPE OF INVENTION

The Applicant has developed an innovative system and method for a multi-area emission reduction reporting scheme. The system and method may apply to emission reporting from aircraft, vessels, road vehicles, and other mechanical vehicles, operating between different areas. The vehicles may encompass an entire transport sector, such as international shipping and international aviation.

This application started with an outline of two methodological barriers to address emissions from international transport, and two trading barriers to the establishment of a relevant emission trading scheme. It also outlined two major overlooked elements that have inhibited creation of holistic approaches to reduce emissions from international transport.

Subsequently, four embodiments for the multi-area emission reporting scheme have been described. The embodiments have eliminated the two methodological barriers outlined. This has been achieved essentially through the novel usage-to-area (UTA) attribution rule 170 and method 40. Method 40 has been enabled by the novel reporting system 20, created to obtain fuel consumption vehicle by vehicle.

Thereafter, the fifth embodiment for the novel multi-area emission reduction system for vehicles 80 has been described, leveraging reporting system 20. Related method 90 for emission reductions has been disclosed, leveraging method 40. The emission reductions would be achieved by employing market mechanisms through a price on vehicle emissions and disbursing of funds raised. The fifth embodiment has addressed the two trading barriers described, namely the need for an emission baseline and agreement on the distribution of emission allowances. The multi-area emission reduction scheme totally eliminates them. In the embodiments, a baseline is not required, removing the need for reliable emission data to start the scheme. Secondly, the agreement on the distribution of emission allowances is made obsolete, as no allowances are required. Instead emission fees are used, as described above.

Furthermore, due to central and simple reporting of fuel consumption, compliance costs are reduced, and incentives for avoidance are lower. Given the vehicle by vehicle reporting adopted, the risk of being caught is high, which further increases compliance. This is true for both emission reporting and reduction schemes.

Various UTA attribution rules have been illustrated that allow differentiation of responsibilities and respective capabilities of different areas. This is intended not only for fair reporting but also to secure wide participation. Based on this, an emission fee for vehicles or another market-based mechanism could be introduced widely, even globally. Furthermore, since the emission fee proposed may be linked to the market emission price, the fee can be market-driven rather than set in an arbitrary manner.

The emission fee may also be linked to an emission cap by using relative definitions for emission projections and the cap. This creates a new hybrid instrument, in which the emission price is linked to the quantity target, the cap, and the prevailing market emission price.

Furthermore, quantitative goals defined as deviations below the business-as-usual emissions have been disclosed and can be used, where needed. This is another advantage. Deviation goals are not that suitable for trading schemes proposed by others. Yet, they may be the only emission reduction goals that some developing countries may accept in near future, in respect of quantity of emissions. Instead of differentiated goals to deliver on differentiated responsibilities embodied in the UNFCCC, embodiment of a simpler rebate mechanism is preferred in this Application.

In the rebate mechanism, developing countries would be entitled to obtain rebates from the revenue raised by the proposed emission reduction schemes. If global, such schemes would generate significant financing (net revenue), after the rebates have been issued. This financing could be disbursed to action on climate change in the most vulnerable developing countries. Thus, both of the two overlooked elements described would also be delivered upon, namely the market-driven emission price and innovative financing for action on climate change.

The top-down use of UTA attribution rules based on share of imports and similar, together with bottom-up collection of fuel consumption, vehicle by vehicle, is novel. It has not been proposed by others so far. This approach offers a different paradigm from the current approaches of attributing international emissions to countries where fuel is sold.

The UTA attribution rule proposed has many advantages. First it better reflects the polluter pays principle, as it is end users of transport who ultimately cause transport emissions. The end users are typically the end customers of imported goods and travelers.

Secondly, it allows differentiating obligations of end users as, by the time the rule is applied, the usage of vehicles is known. Such differentiation is not possible in schemes based entirely on where the fuel is sold.

Thirdly, the UTA rule can be applied in the top-down manner to calculate attributed emissions to each country, or area. The rule effectively splits the total emissions from international transport into attributed emissions country-by-country, ready to be used within national totals. Furthermore, the same approach is used to calculate the rebate for eligible developing countries, offered for participation in a global emission reduction scheme for international transport. Several examples of using the UTA rule based on the country's share of global imports demonstrated the benefits of this approach in practice.

Accordingly, the reader will see that I have provided a description of several embodiments of the invention. While the above description contains many specificities, these should not be construed as limitations of the scope of any embodiment, but as exemplifications of the presently preferred embodiments thereof.

Many other ramifications and variations are possible within the teachings of the various embodiments. For example, a set of hierarchical instances of an embodiment may be implemented. These may be based on enterprise examples described.

For instance, the enterprise results can feed into a higher level system, covering multiple divisions or enterprises. This will create a multi-level or a tree-like application of system 20 for large groups of vehicles. For instance, on the first level, system 20 would operate within divisions, for instance responsible for different ships, such as tankers, bulk carries, container ships, and passenger ships. System 20 operating at the group-level could effectively integrate the divisional reports, and submit a single group report to the regional or global system. In such a multi-level system, UTA rule 170 should typically apply on one level only. On the other level or levels, the rule would not apply making the system there an aggregator of data, while using the same methods disclosed herein.

### Multiple and Differentiated Goals

A set of parallel embodiments of the innovation may also be implemented. For instance, the different sub-sectors of international shipping grow at different rates and the slower growing sub-sectors might be unwilling to share the burden of the rapid growth of the others. The same is true about sharing the burden between countries with different level of economic development. The rebate option implemented in the fifth embodiment addresses the issue of country differentiation to a large degree, but other ways to address this issue are enabled by embodiments of the present invention.

Specifically, emissions may be divided into emission segments or bubbles. Each may even have its own scheme. Furthermore, different emission goals (G) may apply to the segments, such as emission cap (C) and deviation (D). The goal values may differ as well.

Embodiments of the present invention can use both types of goals G. For instance cap C may be used for one segment and deviation D may be used for another segment. The segment may be defined through one or more criteria used, such as type 102, and activities 103, and areas 110 and 120. For instance cap C may be defined for areas defined as developed countries, while deviation D can be used for areas defined as developing countries. Different values may be used for different segments. This includes deviation D of zero, which can be treated as a special “no goal” type of goal.

The different goals are illustrated in Table 10 for three emission segments, A, B, and O. Goal G for segment A is defined as a cap, for segment B as a deviation, and segment O does not have an emission goal.

TABLE 10
Illustrative emission goals for different segments

| | Segments and Goals | | |
|---|---|---|---|
| Segment | A | B | O |
| Goal type | Cap | Deviation | No goal |

Following on the fifth embodiment, illustrated in FIG. 8, using different goals would translate to different emission prices. This would respond to the need of differentiation or different burden sharing. In each case the actual emission price 820 could be calculated through a generic formula: emission price=FR×average MEP.

FR above is the final rate R, calculated from the segment goal, and incorporating any scheme adjustments. The average MEP may be a rolling average of MEP over a predetermined period of time, as previously described. Furthermore, MEP may refer to forward prices. Advantageously, each emission price 820 could then be announced well in advance, providing predictability of costs to the transport sector. This would allow incorporating emission price 820 in prices for transport services before they are sold to end customers.

These embodiments for different segments might share some of the same steps, systems and services. Preferably, they should have very similar data architecture to allow consolidation and combined reporting. This may be implemented as a single central system. The separate embodiments can be started at different times benefiting from the lessons learned and services already established.

Furthermore, the emission fees may further vary per vehicle 100 and fleet 150. For instance, in relation to efficiency indexes for individual vehicles 100, and fleets 150. Each vehicle or fleet could have an efficiency index or a fee factor. The efficiency index may be calculated from a benchmark or a desired value of the efficiency index, and achieved efficiency. For instance, the Energy Efficiency Operational Index or the Energy Efficiency Design Index for ships being developed by the IMO could be applied, once fully developed.

Such embodiments with variable emission fees would be effectively equivalent to emission trading, which used similar benchmarks or efficiency indexes. Thus, the proposed embodiments can deliver not only the same emission targets as emission trading but also provide exactly the same economic incentives, while eliminating the trading barriers as described at the beginning of this section.

### Example of Local Embodiment

The reader will also see that I have generally described examples of UTA rule 170 for which data is easily and widely available. Embodiments of the present invention are not restricted to the use of only widely or globally available data. For these wide-ranging embodiments, this application specifically foresees implementations covering 50 and more countries, separately or jointly for international aviation and international maritime transport. For instance, embodiments using UTA rule 170 based on a country's share of imports are examples of such wide-ranging embodiments.

Variations for national, local and enterprise embodiments are also possible within the teachings of the various embodiments.

For instance, for UTA rules defined through a share of passengers, a global example has not been provided due to the availability of data. However, these rules may be area-centric, such as the share of passengers resident in and traveling to and from an area, included in Table 1. They may also be carrier- or enterprise-centric, such as the share of passengers carried resident in or citizen of an area, included in Table 2. Relevant data is already available for many locations and many carriers, and may become widely available with time. Furthermore, local embodiments are possible with local data, as illustrated below.

The following example embodiment refers to reporting precisely a national share of emissions from international air travel, based on passengers resident in and traveling to and from an area.

Two areas are defined: K and L. Area K is a given country, area L is rest of the world. Vehicles 100 are aircraft flying between K and L. Fuel entities are aircraft operators using vehicles 100. As an example data for K being the USA will be provided.

UTA rule 170 is defined as a share of passengers resident in and traveling to and from an area K (S). Share S can be calculated from yearly international air arrivals and departures. Arrivals are for non-resident visitors (inbound). Departures are for residents (outbound). In this application, these are called visitor arrivals and resident departures, respectively. In the USA data for visitor arrivals and resident departures is provided by the U.S. International Air Travel Statistics (or I-92) program. The data is based on a count of the number of citizens and aliens on each flight. Share S is calculated as a ratio of resident departures divided by the sum of visitor arrivals and resident departures. The formula is: S=resident departures/(visitor arrivals+resident departures).

By way of example, share S is calculated as 58% for the USA for 2005. It is based on 28.9 million of visitor arrivals, and 39.8 million of resident departures, by air. These numbers were obtained from the North American Transportation Statistics (NATS) database, available at http://nats.sct.gob.mx.

If K is defined as Mexico and L being the rest of the world, share S is calculated as 21% for 2005. It is based on 9.9 million of visitor arrivals and 2.6 million resident departures, by air. The data was obtained from the same NATS database.

Comparing the results for the USA and Mexico reveals how significantly shares S can differ between countries. They are 58% and 21% for the USA and Mexico, respectively. Each value quantifies share of usage of international air travel from and to each country, by its residents. Thus, responsibility for the international aviation emissions differs significantly, seen from the perspective of air travel between the given country and the rest of the world. This responsibility can be incorporated in emission reporting through embodiments of the present invention using UTA rule 170.

This example demonstrates another advantage of the present invention. It can reflect the asymmetric responsibility of residents from different countries traveling internationally. This has not been proposed before to the best knowledge of the Applicant. Neither is it possible to use precisely the asymmetric responsibility with the current methods of reporting emissions from international transport.

Similar embodiments and results can be obtained for other countries, using existing data. For instance, in Australia the data for the overseas arrivals and departures can be obtained from the Australian Bureau of Statistics, available at: http://www.abs.gov.au/ausstats/abs@.nsf/mf/3401.0/. Similar data is collected by airports around the world, and border controls. Additionally, data on yearly international arrivals and departures can be obtained from World Development Indicators provided by the World Bank. Although these indicators are labeled international tourist arrivals and departures, they in fact measure overall arrivals and departures of people traveling to and staying in places outside their usual place of residence. However, they only provide a proxy for international aviation as the data counts all international departures and arrivals, including by land.

Embodiments for carrier-centric UTA rules are also possible. However quantitative examples cannot be provided here, as data on share of passengers carried resident in an area is not publicly available. However, many aircraft operators, at least in some countries, have such data. The data is typically collected based on citizenship rather than on resident status, though.

The example also demonstrates that the present invention is not obvious. The data on air arrivals and departures has been collected for many years. Yet such data has never been used with bottom-up reporting of fuel consumption. Together these two data sources can produce an accurate depiction of the share of emissions from air flights to and from the country. The result, as in the example for Mexico, can be unexpected. Only about a fifth of total emissions from air flights from and to Mexico should be accounted to Mexico. Based on current accounting methods, half of all emissions from flights to and from Mexico are accounted to Mexico.

The major advantage of this example embodiment is that it can precisely quantify a country's share of emissions from international aviation that the country should account for. With these emissions predicted to grow further while emissions in other sectors decline they will count for an increasingly larger share of national emissions. Having methods and systems able to fairly quantify each country's share of emissions from international aviation, as well as from international maritime transport, will be increasingly more important.

A variety of other UTA rules 170 may be used, not described in this Application. These include rules based on share of unloaded goods, share of transport work, and similar.

1. A method for reporting emissions from vehicles of a type, from an activity in and between a plurality of areas, over a period of time, each vehicle associated with a fuel entity, the method comprising:
(a) providing an electronic registry through which data is recorded and managed,
(b) registering each said fuel entity as a fleet,
(c) obtaining and recording fuel consumption for substantially each vehicle of said vehicles, for said activity over said period of time, wherein said fuel consumption is obtained from said fleets,
(d) calculating attributed fuel consumption, for at least one area of said plurality of areas, in relation to a total of said fuel consumption and a predetermined usage-to-area attribution rule, wherein said rule is unrelated to both the amount of fuel purchased and fuel consumed at said area,
(e) optionally, deriving attributed emissions from corresponding said attributed fuel consumption, and deriving total emissions from said total fuel consumption,
(f) producing a report containing a result, for at least one area of said plurality areas, wherein said result is selected from the group consisting of {said attributed fuel consumption, and said attributed emissions},
whereby the emissions from said vehicles are equitably apportioned to said plurality of areas accordingly to said usage-to-area attribution rule, and said attributed emissions or said attributed fuel consumption are reported for at least one area, thereby enabling their incorporation in the area-by-area overall emission reporting, and furthermore enabling differentiated emission reduction schemes, including rebates to areas with low responsibilities for and capabilities to reduce emissions.

2. The method of claim 1, wherein said vehicles comprise vehicles selected from the group consisting of {sea going ships of 400 gross tonnage and over, aircraft with a maximum take-off mass greater than 5,700 kg} and said fuel entities are selected from the group consisting of {operators of said vehicles, managers of said vehicles, said vehicles, fuel suppliers for said vehicles, entities responsible for compliance of said vehicles}.

3. The method of claim 1, wherein in (d) said usage-to-area attribution rule is selected from the group consisting of {an area's share of imports, share of goods carried to an area, share of passengers resident in and traveling to and from an area, share of passengers carried resident in or citizen of an area}.

4. The method of claim 1, wherein said type is a selected type of a plurality of types, further comprising the step of: (g) consolidating said report with other reports corresponding to other types in said plurality of types.

5. The method of claim 1, wherein said type is a selected type of one or more types, said activity is a selected activity of one or more activities, further comprising the step of: (g) consolidating said report with other reports corresponding to other types in said one or more types and other activities in said one or more activities.

6. The method of claim 1, wherein said vehicles are aircraft of a predetermined size, said activity is a selected activity of two activities, international flights and domestic flights, further comprising the step of (g) consolidating said report with the other report corresponding to the other activity in said two activities, and wherein for said domestic flights (c) further comprises obtaining fuel consumption per area, and in (d) calculating said attributed fuel consumption is performed by summing up said fuel consumption per area, from all said fleets, for said at least one selected area.

7. The method of claim 1, wherein said vehicles are civil aircraft of a predetermined size, each of said plurality of areas is a country or a group of countries, said activity comprises a domestic activity defined by domestic flights and an international activity defined by international flights, said attributed fuel consumption comprises two parts, an international part and a domestic part, and wherein said predetermined usage-to-area attribution rule comprises an international rule for said international part and a domestic rule for said domestic part, and said domestic rule is related to an area share of total domestic activities and a total domestic share of total activities, wherein said activities are measured in ton-kilometers selected from the group consisting of {revenue ton-kilometers, available ton-kilometers}.

8. The method of claim 1, further comprising:
(g) for each of said fleets, obtaining and recording a fee, for said period of time, wherein said fee relates to corresponding said emissions,
(h) paying out an attributed rebate for at least one of said selected areas, wherein said attributed rebate is related to corresponding said attributed emissions and optionally to a corresponding predetermined rebate rate.

9. The method of claim 1, further comprising:
(g) for each of said fleets, obtaining and recording a fee, for said period of time, wherein said fee relates to corresponding said emissions, the step comprising:
(i) optionally, obtaining and recording one or more prepayments for said fee,
(ii) obtaining and recording a true-up fee, wherein said true-up fee is determined in relation to corresponding said emissions and said prepayments,
(h) paying out an attributed rebate to at least one of said selected areas, wherein said attributed rebate is related to corresponding said attributed emissions and optionally to a corresponding predetermined rebate rate.

10. The method of claim 1, further comprising:
(g) for each of said fleets, obtaining and recording a fee, for said period of time, wherein said fee relates to corresponding said emissions and an emission price, wherein said emission price is established at least partly in relation to a predetermined emission reduction goal,
(h) paying out an attributed rebate to at least one of said selected areas, wherein said attributed rebate is related to corresponding said attributed emissions and optionally to a corresponding predetermined rebate rate.

11. A system for reporting emissions from vehicles, from an activity in and between a plurality of areas, over a period of time, each vehicle of a type and associated with a fuel entity, the system comprising:
(a) an electronic registry through which data is recorded and managed,
(b) means for registering each fuel entity as a fleet,
(c) means for obtaining and recording fuel consumption, for substantially each vehicle of said vehicles, for said activity over said period of time, wherein said fuel consumption is obtained through said fleets,
(d) means for calculating attributed fuel consumption, for at least one area of said plurality of areas, in relation to a total of said fuel consumption and a predetermined usage-to-area attribution rule, wherein said rule is unrelated to both the amount of fuel purchased and fuel consumed at said area,
(e) means for optionally, deriving attributed emissions from corresponding said attributed fuel consumption, and for deriving total emissions from said total fuel consumption,
(f) means for producing a report containing a result, for at least one area of said plurality of areas, wherein said result is selected from the group consisting of {said attributed fuel consumption, and said attributed emissions},
whereby the emissions from said vehicles are equitably apportioned to said plurality of areas accordingly to said usage-to-area attribution rule, and said attributed emissions or said attributed fuel consumption are reported for at least one area, thereby enabling their incorporation in the area-by-area overall emission reporting, and furthermore enabling differentiated emission reduction schemes, including rebates to areas with low responsibilities for and capabilities to reduce emissions.

12. The system of claim 11, wherein said vehicles comprise vehicles selected from the group consisting of {sea going ships of 400 gross tonnage and over, aircraft with a maximum take-off mass greater than 5,700 kg}, and said fuel entities are selected from the group consisting of {operators of said vehicles, managers of said vehicles, said vehicles, fuel suppliers for said vehicles, entities responsible for compliance of said vehicles}.

13. The system of claim 11, wherein said emissions are carbon dioxide emissions, said vehicles are sea going ships of a predetermined size, said type is a selected type of a plurality of types selected from the group consisting of {bulk carrier, tanker, general cargo ship, container ship, combination cargo ship, vehicle carrier-ferry, passenger ship}, further comprising: (g) means for consolidating said report with other reports corresponding to other types in said plurality of types.

14. The system of claim 11, wherein said type is a selected type of one or more types, said activity is a selected activity of one or more activities, further comprising: (g) means for consolidating said report with other reports corresponding to other types in said one or more types and other activities in said one or more activities.

15. The system of claim 11, wherein said emissions are carbon dioxide emissions, said vehicles are sea going ships of 400 gross tonnage and over, said fuel entity is the vehicle itself, said plurality of areas comprises at least 50 countries, each of said countries being one of said areas, and wherein in (d) said predetermined usage-to-area attribution rule is defined by a country's share of imports.

16. The system of claim 11, wherein the emissions are carbon dioxide emissions, said vehicles comprise aircraft flying internationally with a maximum take-off mass greater than 5,700 kg, said activity is any activity not defined as excluded activities, said fuel entity is the aircraft operator, said plurality of areas comprises at least 50 countries, each of said countries being one of said areas, said fuel consumption is fuel used for international flights, excluding fuel used for domestic flights, and wherein in (d) said predetermined usage-to-area attribution rule is defined by a country's share of imports.

17. The system of claim 11, wherein said activity is a selected activity of two types, an international activity and a domestic activity, further comprising: (g) means for consolidating said report with the other report corresponding to the other type in said two activities, and wherein for said domestic activity (c) further comprises means for obtaining fuel consumption per area, and in (d) means for calculating said attributed fuel consumption comprise means for summing up said fuel consumption per area, from all said fleets.

18. The system of claim 11, further comprising:
(g) means for obtaining and recording a fee, for each of said fleets, for said period of time, wherein said fee relates to corresponding said emissions and an efficiency index,
(h) means for paying out an attributed rebate to at least one of said selected areas, wherein said attributed rebate is related to corresponding said attributed emissions and optionally to a corresponding predetermined rebate rate.

19. The system of claim 11, further comprising:
(g) means for obtaining and recording a fee, for said period of time, for each of said fleets, wherein said fee relates to corresponding emissions and an emission price, said emission price being linked to one or more market emission prices selected from the group consisting of {a rolling average of global market price for emissions, a rolling average of market price for emissions established by one or more economy-wide emission reduction schemes, a predetermined emission price floor, a predetermined emission price ceiling},
(h) means for paying out an attributed rebate to at least one of said selected areas, wherein said attributed rebate is related to corresponding said attributed emissions and optionally to a corresponding predetermined rebate rate.

20. A method for reporting emissions from vehicles selected from the group consisting of {sea going ships of predetermined size, aircraft of predetermined size}, from an activity of international transport between a plurality of countries, over a period of time, each vehicle associated with a fuel entity, the method comprising:
(a) providing an electronic registry through which data is recorded and managed,
(b) registering each said fuel entity as a fleet,
(c) obtaining and recording fuel consumption for substantially each vehicle of said vehicles, for said activity over said period of time, wherein said fuel consumption is obtained from said fleets,
(d) calculating attributed fuel consumption, for at least one country of said plurality of countries, in relation to a total of said fuel consumption and a predetermined usage-to-area attribution rule, wherein said rule is selected from the group consisting of {a country's share of seaborne imports, a country's share of airborne imports, a country's share of imports, share of passengers resident in and traveling to and from an a country},
(e) optionally, deriving attributed emissions from corresponding said attributed fuel consumption, and deriving total emissions from said total fuel consumption,
(f) producing a report containing a result, for at least one country of said plurality countries, wherein said result is selected from the group consisting of {said attributed fuel consumption, and said attributed emissions},
whereby the emissions from said vehicles are equitably apportioned to said plurality of countries accordingly to said usage-to-area attribution rule, and said attributed emissions or said attributed fuel consumption are reported for at least one country, thereby enabling their incorporation in the country-by-country overall emission reporting, and furthermore enabling differentiated emission reduction schemes, including rebates to areas with low responsibilities for and capabilities to reduce emissions.
